(19) United States
(12) Patent Application Publication
(10) Pub. No.: US 2026/0045883 A1
(43) Pub. Date: Feb. 12, 2026

(54) VALLEY SENSING IN FLYBACK POWER CONVERTERS

(71) Applicant: Texas Instruments Incorporated, Dallas, TX (US)

(72) Inventors: Michael Lueders, Freising (DE); Prathamesh Pilankar, Bangalore (IN); Suvadip Banerjee, Bangalore (IN)

(21) Appl. No.: 19/016,101

(22) Filed: Jan. 10, 2025

(30) Foreign Application Priority Data
Aug. 6, 2024 (IN) 202441059286

(51) Int. Cl. H02M 3/335; H02M 1/00

(52) U.S. Cl. CPC H02M 3/33569; H02M 1/0009; H02M 1/0029; H02M 1/0058

(57) ABSTRACT

Techniques for valley detection in flyback power converters. In an example, circuitry implementing the techniques is configured to detect a positive slew at the onset of the leakage reset portion of the switching terminal signal, and to blank out the leakage reset portion. The circuitry is also configured to detect a negative slew of the leakage ringing portion of the switching terminal signal, and to blank out any false valley detections that occur during the leakage ringing portion. The blanking periods may be fixed or variable. The circuitry may also be configured to discern the difference between a true valley that reaches zero voltage within the magnetizing ringing portion and a false valley within the leakage ringing portion.

### CROSS-REFERENCE TO RELATED APPLICATION

This application claims the benefit of and priority to India (IN) Provisional Patent Application No. 202441059286 filed on Aug. 6, 2024, which is incorporated herein by reference in its entirety.

### TECHNICAL FIELD

This description relates to power converters, and in particular, to valley sensing in flyback power converters.

### BACKGROUND

A flyback power converter is a switch mode power supply that converts an AC or DC input voltage to one or more regulated DC output voltages. A flyback converter topology generally includes in input capacitor, a primary-side switching element (e.g., metal oxide semiconductor field effect transistor, or MOSFET), a coupled inductor called a flyback transformer, an output diode or rectifier, and an output capacitor. The transformer allows for energy storage, energy transfer, and galvanic isolation between the input and any outputs. The turns ratio between the primary and secondary windings of the transformer can be set to enable the output voltage to be lower or higher than the input voltage. In operation, when the primary-side switching element is closed (on-time, or TON), the primary winding of the transformer is connected to the input voltage and the primary-side current ramps up, thus storing energy in the gap or core of the transformer. During this on-time, the output diode is reverse-biased and off, and the output capacitor supplies the load current. When the primary-side switching element is open (off-time, or TOFF), the current in the transformer transfers to the secondary and flows through the output diode that is now forward-biased, thereby replenishing the output capacitor and supplying the load current. During this process, the secondary-side current ramps down as the transformer core demagnetizes. Some flyback converters use an auxiliary transformer winding for valley sensing and overvoltage-protection, and to generate a low-voltage bias supply. A number of non-trivial issues remain with flyback power converters.

### SUMMARY

In an example, a device includes: a first logic circuit configured to blank out a leakage reset portion of a switching terminal signal, responsive to a first blanking signal; a second logic circuit configured to blank out a leakage ringing portion of the switching terminal signal, responsive to a second blanking signal; a third logic circuit configured to distinguish the leakage ringing portion of the switching terminal signal from a valley that reaches zero volts, responsive to a zero voltage detection (ZVD) signal, the valley included in a magnetizing ringing portion of the switching terminal signal; and a fourth logic circuit configured to declare one or more valleys included in the magnetizing ringing portion of the switching terminal signal, responsive to input from the second and third logic circuits.

In another example, a device includes: a first circuit configured to receive a switching terminal signal of a flyback power converter, the first circuit further configured to detect a leakage reset portion of the switching terminal signal, and to detect one or more valleys of the switching terminal signal; a second circuit configured to generate a blanking signal that at least partially corresponds to the leakage reset portion of the switching terminal signal; and a third circuit configured to receive detections of the first circuit, as well as the blanking signal of the second circuit. The third circuit is further configured to: blank out the leakage reset portion of a switching terminal signal, responsive to the blanking signal; and distinguish between a valley included in a magnetizing ringing portion of the switching terminal signal and a valley included in a leakage ringing portion of the switching terminal signal.

In another example, a device includes: a slew detect circuit having a switching terminal input, and further including a comparator having a threshold voltage input and a comparator output; a zero current detect circuit having an input coupled to the comparator output, and further including a blanking signal input and a zero current detection signal output; a first threshold voltage switchably coupled to the threshold voltage input of the comparator; a second threshold voltage switchably coupled to the threshold voltage input of the comparator; and an adaptive blanking circuit having a clocking input terminal coupled to the comparator output, and further including a blanking signal output, the blanking signal output coupled to the blanking signal input of the zero current detect circuit.

In another example, a method includes: receiving a switching terminal signal, the signal including a leakage reset portion, a leakage ringing portion, and a magnetizing ringing portion; detecting positive slew of the leakage reset portion; generating a blanking signal to blank out the leakage reset portion; and detecting a negative slew of the signal. Responsive to a valley being detected in the signal, the method further includes: declaring a valley if a leakage filter has expired, the leakage filter having a period that is longer than a period of the leakage ringing portion of the switching terminal signal, or declaring a valley if the detected valley has reached zero volts.

### BRIEF DESCRIPTION OF THE DRAWINGS

FIG. 1 illustrates a block diagram of a flyback power converter system configured with a valley sense detect circuit, in an example.

FIG. 2 illustrates an example signal of a switching terminal of a flyback power converter.

FIG. 3 illustrates a block diagram of the valley sense detect circuit of the system of FIG. 1, in an example.

FIG. 4A illustrates a schematic diagram of the valley sense detect circuit of the system of FIGS. 1 and 3, in an example.

FIG. 4B illustrates a schematic diagram of the variable blank delay circuit of the system of FIG. 4A, in an example.

FIG. 4C illustrates a schematic diagram of the leakage filter circuit of the system of FIG. 4A, in an example.

FIG. 5A illustrates plots of signals generated by the system of FIG. 1 when N*VOUT is less than or equal to VIN, in an example.

FIG. 5B illustrates plots of signals generated by the system of FIG. 1 when N*VOUT is greater than VIN, in an example.

FIG. 6 illustrates a flow chart of a method for valley sensing in a flyback power converter, in an example.

FIG. 7 illustrates a block diagram of a system including a flyback power converter configured for valley sensing without using an auxiliary winding, in an example.

### DETAILED DESCRIPTION

Techniques are described herein for valley detection in flyback power converters. The techniques allow a given power converter to carry out valley switching, and can be implemented without an auxiliary transformer winding and the related discrete components. The valley detection is carried out on the signal at the switching node or terminal of the flyback power converter. The efficiency of the power converter can be improved when the switching of the power converter occurs at a given valley, because the switch node is at either zero voltage or a valley voltage at that valley. The techniques further allow false valleys to be distinguished from true valleys. In more detail, in addition to one or more true valleys included in a magnetizing ringing portion of the switching terminal signal, the switching terminal signal may also include one or more false valleys included in, for instance, a leakage reset portion and/or a leakage ringing portion of the switching terminal signal. In an example, circuitry implementing the techniques is configured to detect a positive slew at the onset of the leakage reset portion of the switching terminal signal, and to blank out the leakage reset portion. The circuitry is also configured to detect a negative slew of the leakage ringing portion of the switching terminal signal, and to blank out any false valley detections that occur during the leakage ringing portion. The blanking periods may be fixed or variable. The circuitry may also be configured to discern the difference between a true valley that reaches zero voltage within the magnetizing ringing portion and a false valley within the leakage ringing portion, which is helpful because each of these two valley-types may have negative slew that runs to the corresponding valley in a similar amount of time but only a true valley will reach zero voltage. The techniques thus allow high confidence true valley declarations.

### General Overview

As described above, a number of non-trivial issues remain with flyback power converters. In more detail, existing flyback power converter topologies use an auxiliary winding of the flyback transformer to facilitate functions such as valley sensing. Such aux-based sensing may further necessitate additional discrete components (e.g., high voltage linear regulator) and a separate package pin. The auxiliary winding, additional discrete components and pin increase overall cost and footprint of the converter. Thus, eliminating the auxiliary winding, related discrete components and pin would be beneficial. However, doing so gives rise to the need for a new way to perform valley sensing. One possible approach is to sense valleys of the signal at the switching terminal of the flyback power converter. But, that signal may be associated with a number of parasitic valley-like manifestations (false valleys) that must be distinguished from true valleys that occur during the resonant period of the switching cycle (also referred to as magnetizing ringing, or dead time). For instance, a relatively high frequency ringing (sometimes referred to as leakage ringing), which is largely attributable to parasitic capacitance of the switching element and transformer, occurs on the switching terminal just after the off-time of the switching cycle commences. Also, there is a relatively high amplitude pulse (sometimes referred to as the leakage reset pulse) that occurs between commencement of the off-time and commencement of the high frequency leakage ringing. Switching at false valleys within the leakage reset and leakage ringing portions of the switching terminal signal can cause problems (e.g., shorting of input and output) and should be avoided.

Accordingly, techniques are described herein for providing valley sensing in a flyback power converter topology, without use of an auxiliary winding. In an example, the techniques can be implemented by a circuit configured to sense the valleys of a switching terminal signal (sometimes referred to as a switching node signal). The switching terminal signal may include a leakage reset portion, a leakage ringing portion, and a magnetizing ringing (or resonant) portion. The target valleys to be sensed by the circuit are included in the magnetizing ringing portion (true valleys), but valleys included in other portions of the switching terminal signal (false valleys) may also be sensed. To this end, the circuit is further configured to distinguish false valleys from true valleys, such that only true valleys are declared and false valleys are ignored or otherwise not used for switching. The controller of a flyback power converter that includes or otherwise works in conjunction with the circuit may thus have access to one or more true valley declaration signals, and may choose any declared valley for transitioning to the on-time of the next switching cycle, to facilitate low switching loss.

In an example, the circuit is configured to receive a switching terminal signal, the signal including a leakage reset portion, a leakage ringing portion, and a magnetizing ringing portion. The circuit is further configured to detect positive slew of the leakage reset portion, and generate a blanking signal to blank out the leakage reset portion. The circuit is further configured to detect negative slew of “possible” valleys that occur after the leakage reset portion. The possible valleys may include false valleys to be distinguished from true valleys. To this end, responsive to a valley being detected, the circuit is further configured to determine if a leakage filter has expired, the leakage filter having a period that is longer than a period of the leakage ringing portion of the switching terminal signal. If the leakage filter has expired by the time the valley is detected (indicative of a true valley), the circuit is configured to declare that valley as a true valley. If, however, the leakage filter has not expired (potentially indicative of a false valley), the circuit is further configured to determine if the detected valley reached zero volts (indicative of a true valley). If the detected valley reached zero volts, the circuit is configured to declare that valley as a true valley; and if the detected valley did not reach zero volts (indicative of a false valley), the circuit can distinguish that valley from a true valley (e.g., no valley declaration is made). A valley declaration can be made, for example, via the output of a logic circuit, such as the example case where a logic 1 output means a valley is declared, and a logic 0 output means no valley is declared. The circuit may detect and declare one or more true valleys included in the magnetizing ringing portion. A controller may receive the valley declaration signal(s), and cause the switching element to turn on at a time corresponding to the occurrence of a true valley.

### Circuit Architecture

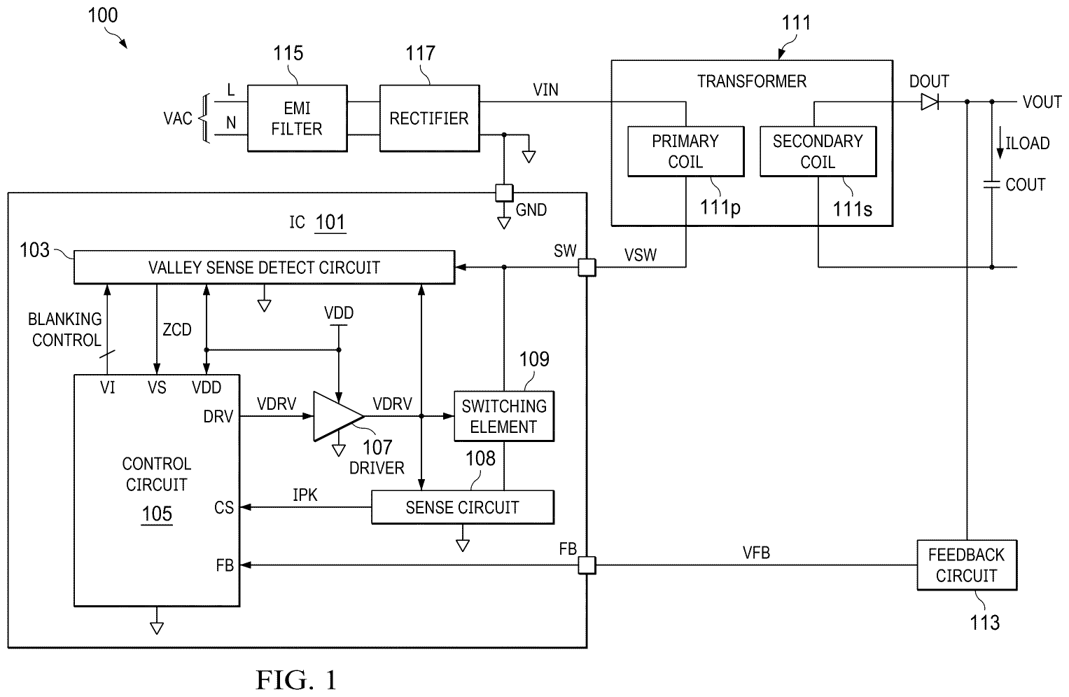

FIG. 1 illustrates a block diagram of a flyback power converter system 100 configured with a valley sense detect circuit, in an example. As shown, system 100 includes an integrated circuit (IC) 101, a flyback transformer 111, an output diode DOUT, an output capacitor COUT, a feedback circuit 113, an electromagnetic interference (EMI) filter 115, and a rectifier 117. In this example, flyback power converter system 100 converts an AC input voltage (VAC) to a DC input voltage (VIN) which is in turn converted by system 100 to a regulated DC output voltage (VOUT). In other examples, the DC input voltage VIN may be sourced directly, rather than derived from AC input voltage VAC.

As further shown, IC 101 includes a valley sense detect circuit 103, a control circuit 105, a driver 107, a sense circuit 108, and a switching element 109, all of which may be populated on a given substrate, such as on or otherwise part of an integrated circuit die within an integrated circuit package (e.g., ceramic flat pack with leads, dual in-line, ball grid array, pin grid array, land grid array, leaded chip carrier, quad flat no lead, to name a few examples), or on or otherwise part of a printed circuit board (e.g., single-sided, double-sided, multilayer, flex, to name a few examples), or on or otherwise part of any other suitable substrate upon which circuitry may be formed and/or populated. Each of flyback transformer 111, DOUT, COUT, feedback circuit 113, EMI filter 115, and rectifier 117 are shown to be external to IC 101 in this example, but in other examples any one or more of these components or circuits may be integrated within IC 101. An electronic system to be powered may also be coupled between the VOUT and ground terminals of system 100. The electronic system, represented here as a load current (ILOAD), may be configured to suit any number of applications (e.g., automotive systems, computing systems, communications systems, gaming systems, household appliances and consumer electronic systems, mobile electronic systems such as smartphones, or any other application that utilizes regulated power). Other examples of flyback power converter system 100 may include additional componentry not shown and/or be configured differently, and any such systems may benefit from the techniques described herein.

EMI filter 115 removes unwanted noise from the line voltage, and rectifier 117 rectifies the AC input. Any suitable EMI filter and rectifier circuitry can be used. Other examples may have VIN directly applied rather than derived from an AC source as shown. In such cases, system 100 may not include VAC, EMI filter 115, and rectifier 117. Transformer 111 allows for energy storage, energy transfer, and galvanic isolation between the input VIN and output VOUT. The turns ratio between the primary and secondary windings 111p and 111s, respectively, can be set to enable VOUT to be lower or higher than VIN. Any suitable flyback transformer may be used. In this example, flyback transformer 111 does not include any auxiliary winding used for valley sensing. Other examples may include one or more auxiliary windings, for instance, to provide another option for carrying out valley detection, and/or for providing overvoltage protection and/or a bias supply.

Switching element 109 can be any suitable switching element technology, such as a gallium nitride field effect transistor (GaN FET) or other power FET, or a power bipolar junction transistor (BJT). In this example, switching element 109 is coupled between the SW and ground terminals of IC 101 via its current terminals (e.g., source/drain terminals for a FET, or emitter/collector terminals for a BJT), with sense circuit 108 coupled between switching element 109 and ground. The control terminal (e.g., gate terminal for a FET, or base terminal for a BJT) of switching element 109 is coupled to the output of driver 107. When switching element 109 is closed (on-time, or TON), primary winding 111p is connected to the input voltage VIN and the primary-side current ramps up, thus storing energy in the core of transformer 111. During this on-time, diode DOUT is reverse-biased and off, and capacitor COUT supplies the load current. When switching element 109 is open (off-time, or TOFF), energy stored in the core of transformer 111 transfers to the secondary winding 111s and flows through diode DOUT (now forward-biased), thereby replenishing capacitor COUT and supplying the load current ILOAD. During this process, the secondary-side current ramps down as the transformer 111 core demagnetizes. The closing and opening of switching element 109, including valley switching, is controlled by IC 101, as further explained below.

Sense circuit 108 senses the primary-side peak current IPK and provides that current information (which may be a scaled version of the actual primary-side peak current IPK) to control circuit 105. The peak current IPK depends on ILOAD and the input line conditions. Any suitable current sensing circuitry that allows control circuit 105 to receive or otherwise determine the primary-side peak current IPK may be used, such as a resistor-based current sensing circuit that includes a sense FET or BJT that is a scaled down replica of switching element 109. In some examples, sense circuit 108 may also compare IPK of a given switching cycle to a reference current, and generate a current limit signal if the IPK exceeds the reference current. In such cases, the current limit signal can be provided to control circuit 105, which can in turn initiate one or more remedial actions (e.g., assert current clamping circuit, shut down converter, disconnect VIN, etc.). Feedback circuitry 113 senses the output voltage and provides a feedback voltage VFB signal to control circuit 105. The VFB signal may be, for instance, a scaled down version of VOUT. Any suitable feedback circuitry that allows control circuit 105 to receive or otherwise determine VOUT may be used, such as a resistive divider and/or an optocoupler feedback circuit as is sometimes used in flyback topologies.

As further shown, the input voltage VIN is applied to one terminal of the primary-side winding, and the other terminal of the primary-side winding is coupled to a switching node (SW) terminal of IC 101, so that IC 101 receives the switching node voltage (VSW) signal. Also, a system ground (GND) is coupled to a ground terminal of IC 101, the IPK signal generated by sense circuit 108 is coupled to a current sense (CS) terminal of IC 101, and the VFB signal generated by feedback circuit 113 is coupled to a feedback (FB) terminal of IC 101. Also, a power supply voltage VDD may be generated on IC 101, or received via another terminal of IC 101, and can be used to power circuitry therein as needed. Other examples may be configured differently and/or include other componentry, and any such configurations may benefit from the techniques described herein.

In an example operation, valley sense detect circuit 103 receives the VSW signal from the SW terminal and a blanking control signal from control circuit 105, and generates one or more zero current detection (ZCD) signals. In some examples, multiple ZCD signals are generated, and may be collectively referred to as a valley train. In any such cases, a given ZCD signal identifies when voltage across switching element 109 is at a low point. Switching at any one of these valleys (also called valley switching) allows for relatively low switching losses, relative to switching when current through switching element 109 is higher. Control circuit 105 receives the VFB signal at its FB input terminal, the IPK signal at its CS terminal, and the one or more ZCD signals at its valley sense (VS) input terminal, and provides a corresponding drive voltage (VDRV) signal at its DRV output terminal. The VDRV signal, which may be, for instance, a pulse width modulated (PWM) signal, is applied to the control terminal of switching element 109 via driver 107, and may be configured by control circuit 105 to facilitate valley switching, based on the one or more ZCD signals.

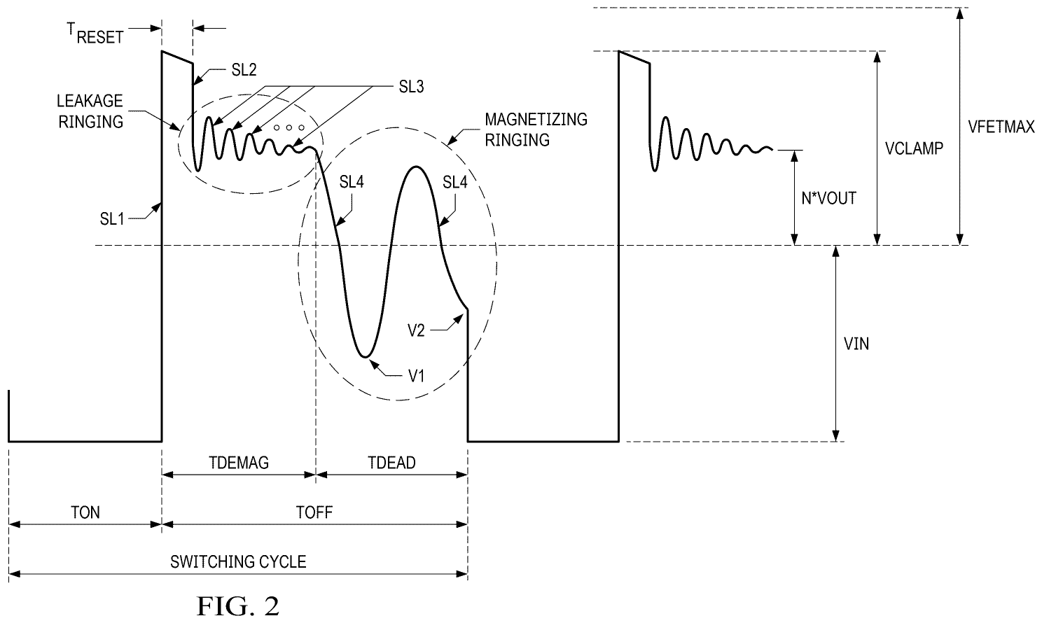

In some examples, and as further described below, the blanking control signal provided by control circuit 105 indicates the valley included in a given valley train at which switching is currently being carried out by control circuit 105, and this valley determines a blanking time used by the valley sense detect circuit 103. In some such examples, the blanking time is highest for the first (deepest) valley, and is relatively shorter for subsequent valley groups. Control circuit 105 can be any suitable flyback converter control circuit configured for valley switching, except that control circuit 105 may be modified or otherwise further configured to provide the blanking control signal indicative of the valley at which switching is being carried out, which in this example is provided at a dedicated valley indication (VI) output terminal. Other examples may provide the blanking control signal via, for example, a general output terminal, and still other examples may be configured to provide a valley-aware blanking time (rather than configure valley sense detect circuit 103 to determine the valley-aware blanking time based on a valley number received from control circuit 105). Valley sense detect circuit 103 is further described below with reference to the examples of FIGS. 2-6.

FIG. 2 illustrates an example signal of the switching terminal (or switching node, or switch node, all used interchangeably herein) of a flyback power converter. The signal may be, for instance, the VSW signal at the SW terminal of IC 101, in the example system 100 of FIG. 1. The signal is not intended to be drawn to scale, but rather is provided to show various example aspects of the signal that may manifest, and which may vary from one example to the next. As shown, a single switching cycle of the signal includes an on-time (TON) portion and an off-time (TOFF) portion. The TOFF portion includes a demagnetization (TDEMAG) portion and a resonate or deadtime (TDEAD) portion. The TDEMAG portion includes a leakage reset (TRESET) portion and a leakage ringing portion. The TDEAD portion includes a magnetizing ringing portion that includes a number of valleys (V1, V2, . . . ). In this example, switching occurred on the second valley V2, and a new switching cycle begins. Other examples may switch on the first valley V1, or a later valley (e.g., V3, V4, etc), depending on peak current IPK. For example, the highest IPK range can be provided by switching at valley VI, the second highest IPK range can be provided by switching at valley V2, and the remaining lower IPK range can be provided by switching at valley V3. Other examples may carry out valley switching according to a different scheme.

As further shown in FIG. 2, there is a positive slew SL1 at the onset of the TRESET portion. The shape of the peak of the TRESET portion can vary from one configuration to the next, but in this example, slopes slightly downward from left to right. Other examples may slope upward and/or slope more severely, or be more curvilinear, or not slope or curve at all. Also, the duration of TRESET is a function of the peak current IPK. The higher the value of the peak current IPK, the longer the duration of TRESET. At the end of the TRESET window, there is a steep negative slew SL2, which can be confused with the negative slews SLA in the magnetizing ringing portion. Thus, in an example, power converter system 100 is configured with a positive slew detector for detecting SL1, and to initiate an IPK-aware blanking time that extends for the duration of the TRESET portion. In this manner, a false valley declaration responsive to negative slew SL2 can be avoided.

As further shown in FIG. 2, the leakage ringing portion includes multiple occurrences of negative slew SL3, which can also be confused with the negative slews SL4 in the magnetizing ringing portion. However, the negative slews SL3 can be distinguished from the negative slews SL4, in an example. In more detail, the ringing of the leakage ringing portion is due to switch node parasitics such as parasitic capacitance of switching element and transformer, and has a relatively higher frequency than the ringing of the magnetizing ringing portion. The ringing of the magnetizing ringing portion occurs when the secondary winding energy declines toward (or to) zero. For a given application, the slowest leakage ringing may be, for instance, 2× or more higher than the fastest magnetizing ringing. This means that any given slew SL3 will end more quickly than the slew SL4 of the first valley V1. Thus, in an example, system 100 is configured with a negative slew detector that works in conjunction with a leakage filter having a period that is longer than any signal period of the leakage ringing, but shorter than the time it takes for the slew SL4 of the first valley to end, such that only detected valleys that occur after the leakage filter has expired are declared. In this manner, a false valley declaration responsive to any negative slew SL3 of the leakage ringing portion can be avoided.

As further shown in FIG. 2, valley VI is rounded, because it does not reach ground. This occurs when N*VOUT is less than or equal to VIN, where N is the turns ratio of transformer 111. In such cases, the corresponding slew SL4 runs its natural course without reaching zero voltage, and the above described leakage filter expires before the valley voltage is reached, thus allowing that non-zero voltage valley to be declared. However, when N*VOUT is greater than VIN, then valley VI reaches zero voltage and the corresponding slew SL4 terminates more quickly. In such cases, the above described leakage filter may not yet have expired by the time zero voltage level is reached, which without more may cause a failure to declare valley V1. Thus, in an example, system 100 is configured with a zero voltage detect (ZVD) circuit for detecting when zero voltage is reached, and logic to detect the simultaneous occurrence of a ZVD (zero voltage) condition and a ZCD (zero current condition or valley detection) condition. The ZVD circuit also acts as a slew detector, so its output may toggle responsive to slew; however, its output and the output of the above described negative slew detector only agree when the voltage VSW of the switching terminal SW goes to zero voltage (ground). Otherwise the respective output waveforms of these two slew detect circuits are inverted with respect to each other. The logic is configured to sense the agreement of these two circuits, and thus can distinguish a false valley within the leakage ringing portion from a true valley within the magnetizing ringing portion. In this manner, a true valley declaration responsive to a negative slew SL4 that reaches zero voltage prior to expiry of the leakage filter can be made, while a false valley declaration attributable to mere leakage ringing can be avoided.

### Valley Sense Detect Circuit

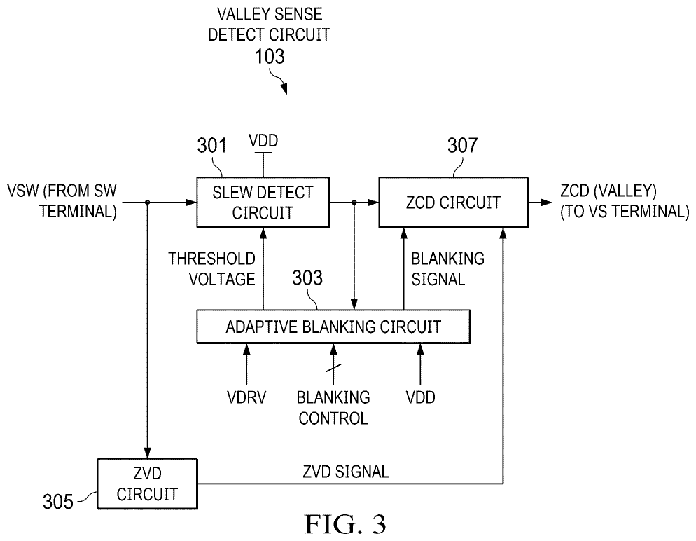

FIG. 3 illustrates a block diagram of the valley sense detect circuit 103 of the system 100 of FIG. 1, in an example. As shown, circuit 103 includes a slew detect circuit 301, an adaptive blanking circuit 303, a zero voltage detect (ZVD) circuit 305, and a zero current detect (ZCD) circuit 307. Other examples may be configured differently, and with different integration schemes, but still operate to provide similar functionality. For instance, in another example, each of slew detect circuit 301, adaptive blanking circuit 303, and zero voltage detect (ZVD) circuit 305 may be integrated into ZCD circuit 307. In an example operation, circuit 103 receives the switching terminal signal VSW at its input, and generates one or more ZCD signals at its output. The VSW signal includes a leakage reset portion, a leakage ringing portion, and a magnetizing ringing portion. Each ZCD signal indicates the occurrence of a valley within the magnetizing ringing portion of the VSW signal. A flyback converter control circuit (e.g., 105) can use the ZCD signals to provide valley switching. Advantageously, no auxiliary winding is needed in generating the one or more ZCD signals.

Slew detect circuit 301 includes an input that receives power supply VDD and another input that receives the switching terminal signal VSW (from the SW terminal of system 100). Slew detect circuit 301 is configured to detect the positive slew at the onset of the leakage reset portion of the VSW signal, and to detect the negative slew of one or more valleys of the VSW signal. As described above, the valleys may be false valleys of the leakage ringing portion, or true valleys of the magnetizing ringing portion. As further shown, slew detect circuit 301 further includes a threshold voltage input that receives an adjustable threshold voltage from adaptive blanking circuit 303, which in turn allows slew detect circuit 301 to detect either positive slew (e.g., when the threshold voltage is high or otherwise set to a first value, such as 600 millivolts (mv)) or negative slew (when the threshold voltage is low or otherwise set to a second value, such as ground or 0 volts). The output of slew detect circuit 301 is provided to both adaptive blanking circuit 303 and ZCD circuit 307.

Adaptive blanking circuit 303 includes an input that receives power supply VDD, another input that receives the output of slew detect circuit 301, and another input that receives the VDRV signal generated by control circuit 105, and an output that provides the threshold voltage to slew detect circuit 301. In an example, adaptive blanking circuit 303 is configured to provide one of first and second threshold voltages, based on those three inputs, wherein the first threshold voltage allows slew detect circuit 301 to operate as a positive slew detector configured to detect the leakage reset portion of the VSW signal, and the second threshold voltage allows slew detect circuit 301 to operate as a negative slew detector configured to detect one or more valleys of the VSW signal. Adaptive blanking circuit 303 further includes another input that receives the blanking control signal generated by control circuit 105, and is configured to generate a corresponding IPK-aware blanking signal, which is in turn provided to ZCD circuit 307 via another output of adaptive blanking circuit 303.

ZVD circuit 305 includes an input that receives the VSW signal, and is configured to generate a zero voltage detection (ZVD) signal responsive to a valley included in the magnetizing ringing portion of the VSW signal reaching zero volts. The ZVD signal is provided to ZCD circuit 307 via an output of ZVD circuit 305.

ZCD circuit 307 includes an input that receives detections of slew detect circuit 301, and another input that receives the blanking signal of adaptive blanking circuit 303. ZCD circuit 307 is configured to blank out slew detections associated with the leakage reset portion of the VSW signal, responsive to the blanking signal, and is further configured distinguish between a true valley included in the magnetizing ringing portion of the VSW signal and a false valley included in the leakage ringing portion of the VSW signal. ZCD circuit 307 further includes another input that receives the ZVD signal from ZVD circuit 305, and is further configured to distinguish between a true valley included in the magnetizing ringing portion of the VSW signal and that reaches zero volts and a false valley included in the leakage ringing portion of the VSW signal. Valley declarations in the form of zero current detection (ZCD) signals generated by ZCD circuit 307 are provided at an output of ZCD circuit 307, which in turn can be provided to the VS terminal of control circuit 105. Control circuit 105 can use the ZCD signals to conduct valley switching, in an example.

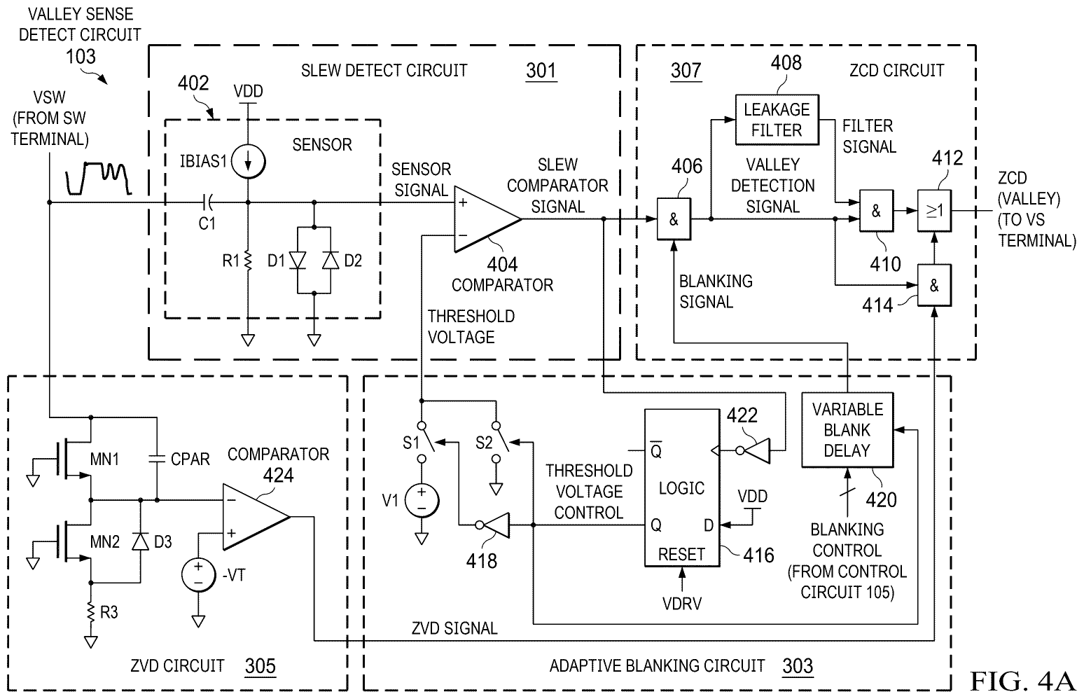

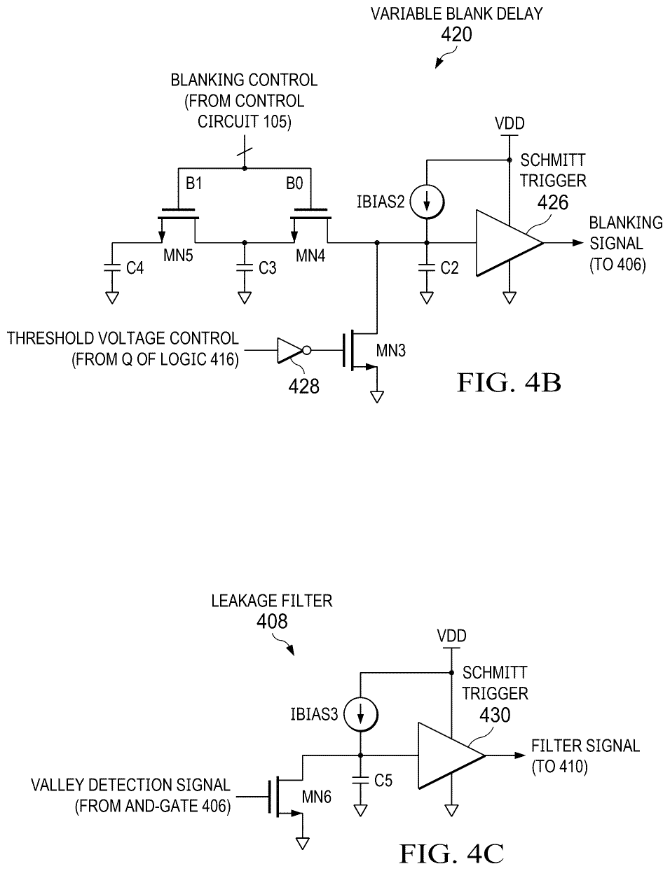

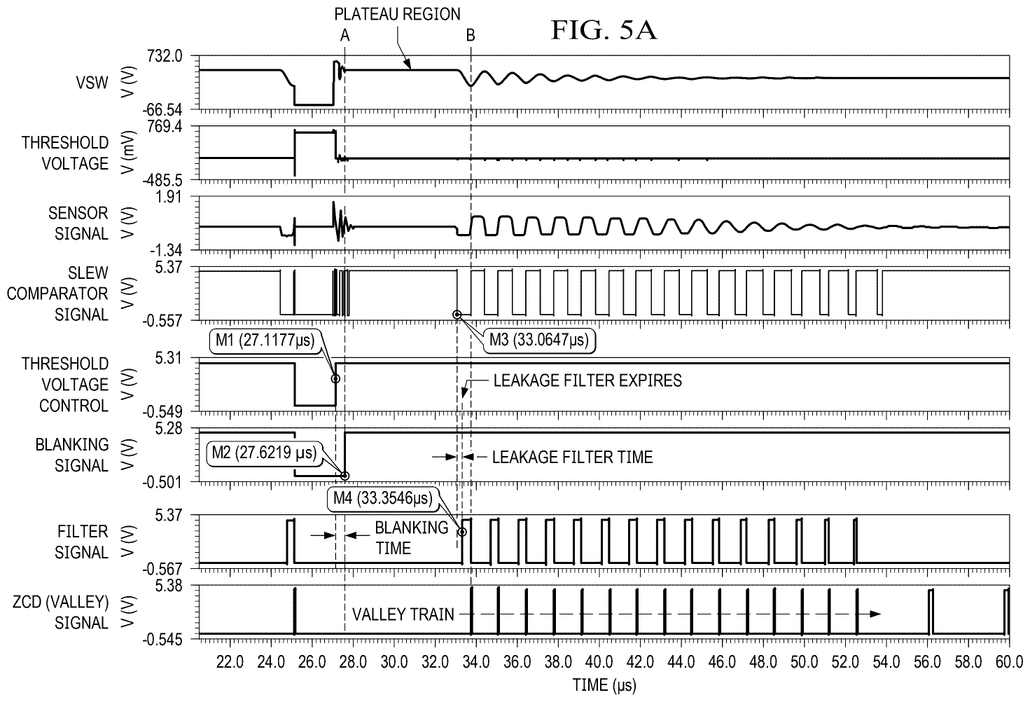

FIG. 4A illustrates a schematic diagram of valley sense detect circuit 103 of FIG. 3, in an example. The above relevant description with respect to circuit 103 is equally applicable here, and is further expanded on with example arrangements of circuitry to implement the functionality described herein. Other examples may be configured differently, but still achieve similar functionality.

In this example, slew detect circuit 301 is configured to sense valleys of the switching node VSW signal using capacitive slew detection and includes sensor 402 and comparator 404. Sensor 402 includes current source IBIAS1, capacitor C1, resistor R1, and a clamp that includes diodes D1 and D2. Each of these components can be rated to meet the specifications of the given application (e.g., high-voltage automotive applications where VSW can vary over a wide range, such as from −2 volts to 1000 volts). Although sensor 402 is shown as a separate circuit, some or all of it may be integrated with other componentry. For instance, in some examples, capacitor C1 is a high-voltage metal-insulator-metal (MIM) capacitor (e.g., 150 picofarads, 700 volts) that is integrated with a semiconductor die that also includes switching element 109 (e.g., GaN power FET). Resistor R1 and current source IBIAS1 can be set to provide a bias voltage level at the output node of sensor 402 (e.g., just above ground potential, such as in the range of 50 mv to 100 mv). For instance, and continuing with the above example where capacitor C1 is about 150 femtofarads (e.g., 700 volt rating), resistor R1 can be set to about 50 KΩ and current source IBIAS1 can be set to about 1.0 to 1.25 microamps, so as to bias the output node of sensor 402 to about 50 mv to 62.5 mv. In an example operation, IBIAS1, C1, and R1 effectively convert the SW node slew to current, and the D1−D2 clamp is used to restrict voltage swing (e.g., limit to about 0.6 volts or 0.7 volts, for silicon diodes). Other suitable slew detector configurations may be used.

As further shown, comparator 404 receives the sensor signal of sensor 402 at its non-inverting input and a threshold voltage at its inverting input, and generates a slew comparator signal at its output. In this example, the threshold voltage is variable and set by adaptive blanking circuit 303, based on the slew comparator signal from comparator 404 and the drive signal VDRV from control circuit 105. Generally, when drive signal VDRV is high (TON portion of switching cycle), a first threshold voltage is applied to the inverting input of comparator 404, which allows comparator 404 to detect positive slew at the onset of the leakage reset portion of the VSW signal after drive signal VDRV goes low (TOFF portion of switching cycle); and after that positive slew is detected, a second threshold voltage is applied to the inverting input of comparator 404, which allows comparator 404 to detect negative slew of the VSW signal that occurs after the leakage reset portion. In an example, the first threshold voltage is 600 mv (within a tolerance acceptable for the given application, such as +/−10 mv) and the second threshold voltage is ground potential (e.g., 0 volts+/−10 mv).

With further reference to the example of FIG. 4A, adaptive blanking circuit 303 is configured to provide the variable threshold voltage, as well as a variable blanking signal that at least partially corresponds to the leakage reset portion of the VSW signal. As described above, the variable threshold voltage can be set to bias slew detect circuit 301 to detect positive slew (first threshold voltage value) or negative slew (second threshold voltage value), and the blanking signal effectively allows the leakage reset portion of the VSW signal to be ignored for purposes of valley detection. As shown, adaptive blanking circuit 303 includes logic 416, an inverter 418, a variable blank delay 420, switches S1 and S2, and a voltage source V1. In this example, logic 416 is implemented with a D-type synchronous, active high reset, positive edge triggered flip-flop, wherein drive signal VDRV is applied to the reset input of logic 416, the data (D) input of logic 416 is tied high via power supply VDD, and the clock input of logic 416 receives the slew comparator signal from circuit 301 by way of inverter 422. The threshold voltage control signal at the Q output of logic 416, in conjunction with inverter 418, controls switches S1 and S2 in a complementary fashion as follows: when the Q output of logic 416 is high, switch S1 is open and switch S2 is closed; and when the Q output of logic 416 is low, switch S1 is closed and switch S2 is open.

In an example operation, when the VDRV signal is high (during the TON portion of the VSW signal, for a current switching cycle), logic 416 is reset and the threshold voltage control signal at the Q output of logic 416 is low, which causes switch S1 to be closed and switch S2 to be open, such that the threshold voltage at the inverting input of comparator 404 is equal to the value of voltage source VI (e.g., 600 mv). When the VDRV signal goes low (which initiates the TOFF portion of the VSW signal, for the current switching cycle), logic 416 becomes set or otherwise ready to be triggered by the next positive going edge received at the clock input of logic 416. In this manner, logic 416 effectively waits for the first (next) positive edge on its clock input, which in this example case corresponds to the first negative going (falling) edge of the sensor signal, as inverted by inverter 422. The first negative going (falling) edge occurs just after the first positive going (rising) edge of the sensor signal, which corresponds to the positive slew SL1 (FIG. 2) of the VSW signal, at the onset of the leakage reset portion. In more detail, when slew SL1 reaches its peak, the sensor signal output by sensor 402 stops rising and begins to fall. This falling edge of the sensor signal is converted to a positive going edge by inverter 422, and this positive going edge is received at the clock input of logic 416. This positive going edge triggers a change in state of the threshold voltage control signal at the Q output of logic 416 from low to high, which in turn causes switch S2 to close (so as to connect the inverting input of comparator 404 to ground), and switch S1 to open (so as to disconnect V1). This high state of the threshold voltage control signal at the Q output of logic 416 is held until VDRV goes high again (which initiates the TON portion of the next switching cycle), which resets logic 416 and thus causes the threshold voltage control signal at the Q output of logic 416 to go low, which in turn causes switch S1 to close (so as to reconnect the inverting input of comparator 404 to V1), and switch S2 to open (to disconnect the ground at the inverting input of comparator 404). The process repeats for that switching cycle, and so on.

As further shown in FIG. 4A, variable blank delay 420 receives the threshold voltage control signal form the Q output of logic 416, and further receives a blanking control signal from control circuit 105. As explained above, the threshold voltage control signal from the Q output of logic 416 transitions from low to high at the onset of the TON portion of a given switching cycle, responsive to the VDRV signal transitioning from low to high. The blanking control signal indicates the number of the valley at which switching desired. In this manner, the blanking signal provided by variable blank delay 420 is set based on that valley number, which is an analog of the corresponding peak current IPK.

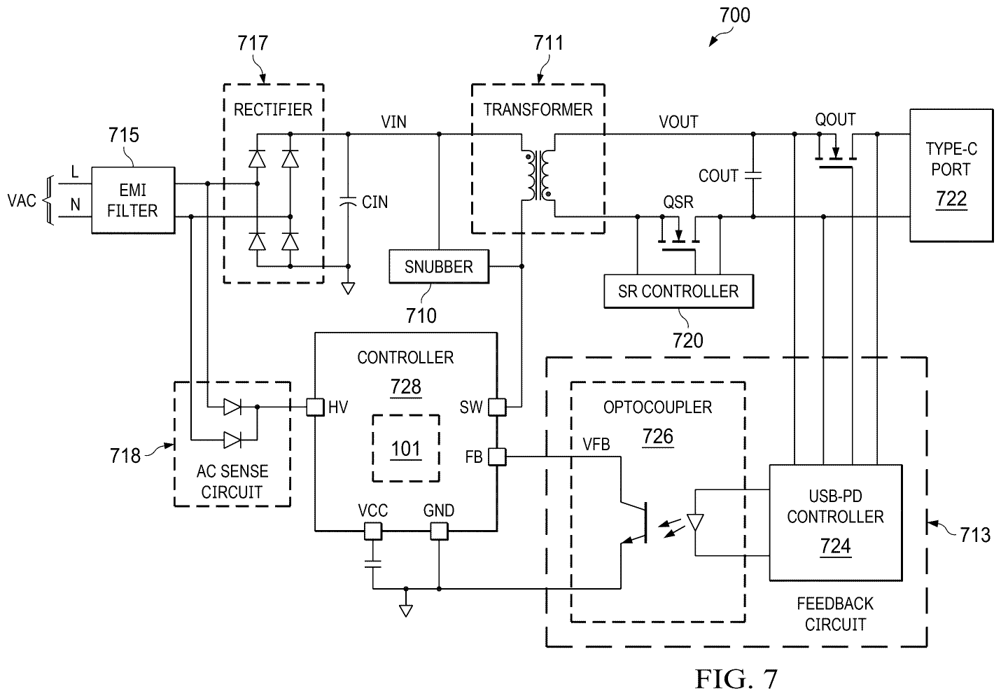

In more detail, the leakage reset time (TRESET, shown in FIG. 2) may be determined as:

$$TRESET = \frac{IPK}{\frac{VCLAMP - N \times VOUT}{LK}} = \frac{IPK \times LK}{VCLAMP - N \times VOUT} , \qquad ( Equation 1 )$$

wherein IPK is the peak current through primary-side inductor, LK is the leakage inductance of the flyback power converter, VOUT is the output voltage of the flyback power converter, N is the turns ratio of the flyback transformer, and VCLAMP is the clamp voltage (shown in FIG. 2, and provided by snubber 710 in FIG. 7). VCLAMP may be computed by:

VCLAMP=% Margin*VFETMAX−VINMAX (Equation 2),

wherein VFETMAX is the maximum voltage rating of switching element 109, the percent (%) margin provides some margin at that maximum rating, and VINMAX is the peak DC voltage based on the universal AC line range. The total demagnetization time (TDEMAG, shown in FIG. 2) may be determined as:

$$TDEMAG = \frac{IPK}{\frac{N \times VOUT}{Lm}} , \qquad ( Equation 3 )$$

wherein Lm is the magnetizing inductance. For a given flyback power converter system, the maximum TRESET can be higher than the minimum TDEMAG. To address this issue, variable blank delay 420 can be configured to provide an adaptive reset blanking period (via the blanking signal at its output) based on IPK, in an example. In such an example, this adaptive reset blanking period can be implemented using the valley numbers as analogues of IPK information. Table 1 below shows some such examples.

As shown in Table 1, N is about 6 or 7.5, Lm is in the range of about 150 microHenries (μH) to 350 μH, LK is in the range of about 1.5 μH to 7 μH, percent (%) margin is about 0.95, VFETMAX is about 650 volts (e.g., maximum voltage of GaN power FET), the universal AC line range is about 85 VAC to 264 VAC, 47 Hz to 60 Hz, VINMAX is about 375 volts (e.g., 264 VAC*sqrt (2)), VOUT is about 20 volts, IPK is about 3.5 amps, and the resulting TRESET is in the range of about 43 nanoseconds (ns) to 265 ns. The blanking time manifested in the blanking signal generated by variable blank delay 420 can thus be IPK-aware and set to slightly longer than TRESET for a given configuration, such as the example case where the blanking time manifested in the blanking signal is set to about TRESET plus about another 50 ns to 500 ns (or other margin appropriate for the given application). Other examples may be configured differently and thus have different parameter values (e.g., N, Lm, LK, % margin, VFETMAX, VINMAX, VOUT, and IPK) and an accordingly different TRESET value. An example such IPK-aware (and valley-aware) blanking signal scheme is further described below, with reference to the example of FIG. 4B.

TABLE 1
Example parameter values to compute TRESET

| | | | Clamp Voltage − N*VOUT | |
|---|---|---|---|---|
| | | | (e.g., (0.95*650 − | TRESET |
| | Lm | LK | 375) − N*20) | (e.g., IPK = 3.5 amps) |
| N | (μH) | (μH) | (volts) | (ns) |
| 6 | 150 | 1.5 | 122.5 | 43 |
| | | 3 | 122.5 | 86 |
| | 350 | 3.5 | 122.5 | 100 |
| | | 7 | 122.5 | 200 |
| 7.5 | 150 | 1.5 | 92.5 | 57 |
| | | 3 | 92.5 | 113.5 |
| | 350 | 3.5 | 92.5 | 133 |
| | | 7 | 92.5 | 265 |

FIG. 4B illustrates a schematic diagram of variable blank delay 420 of the system of FIG. 4A, in an example. As shown, variable blank delay 420 includes capacitors C2, C3 and C4, a current source IBIAS2, a Schmitt trigger 426, transistors (switches) MN3, MN4, and MN5, and inverter 428. Capacitors C2, C3 and C4 are coupled between the input of Schmitt trigger 426 and ground, with capacitors C3 and C4 being switchable via transistors MN4 and MN5, respectively, based on the value of the blanking control signal (which in this example case is a 2-bit control signal), and with capacitor C2 being switchable via transistor MN3 based on the threshold voltage control signal from the Q output of logic 416. In this example, each of transistors MN3, MN4, and MN5 is implemented with an n-type field effect transistor (NFET), but any suitable switching technology can be used (e.g., p-type FETs, single-pole, single throw switches, or any other controllable switch). Other examples may be configured differently but achieve similar functionality.

In an example operation, when the threshold voltage control signal from the Q output of logic 416 goes low (responsive to the VDRV signal going high during the TON portion of the VSW signal), the output of inverter 428 goes high, which in turn causes transistor MN3 to turn on (close), thereby pulling the input node of Schmitt trigger 426 to a low state, which in turn causes the blanking signal output of Schmitt trigger 426 to go low. Subsequently, when the threshold voltage control signal from the Q output of logic 416 goes high (responsive to the VDRV signal going low during the TOFF portion of the VSW signal), the output of inverter 428 goes low, which in turn causes transistor MN3 to turn off (open), thereby releasing the pull-down on the input node of Schmitt trigger 426 and allowing capacitor C2, as well as C3 and C4 if switched in via MN4 and MN5, respectively, to be charged with constant current source IBIAS2. When the voltage on the input node of Schmitt trigger 426 (and across the one or more of capacitors C2, C3 and C4) reaches the high threshold of Schmitt trigger 426 (VTH_SCHMITT_426), the blanking signal output of Schmitt trigger 426 goes high and remains high until the onset of the next switching cycle. The duration of the low state of the blanking signal that occurs prior to the threshold voltage control signal going high can be ignored, as it corresponds to the TON portion of the VSW signal (no valley switching takes place). However, the duration of the low state of the blanking signal that occurs after the threshold voltage control signal goes high corresponds to the actual blanking time, and can be determined as:

BLANKING TIME=TOTAL_CAPACITANCE*VTH_SCHMITT_426/IBIAS2 (Equation 4).

The blanking time can be increased by adding more capacitance by turning on one or both of MN4 and MN5. As described above, longer blanking times are appropriate when switching on the first or second valleys, which in turn correspond to higher peak currents IPK and longer TRESET duration.

Table 2 below shows how the blanking time (e.g., the duration that the blanking signal remains in its low state, as measured from when the threshold control voltage signal goes high) can be set depending on the valley number at which switching occurs, and how the blanking control signal from control circuit 105 can be set to provide that blanking time to variable blank delay 420. For this example, the following example values for variable blank delay 420 are used: C2 is 400 femtofarads, C3 and C4 are each 200 femtofarads, IBIAS2 is about 2 microamps, and the high threshold of Schmitt trigger 426 (VTH_SCHMITT_426) is 1.25 volts. Other examples may be configured differently, such as with different component values, fewer or more selectable blanking times (e.g., 1 or 2 blanking times, or 4 or 5 blanking times), and a smaller or larger control signal (e.g., 1-bit control signal, or 3-bit control signal).

TABLE 2
Valley-aware (and IPK-aware) Blanking Signal Scheme

| Valley | Blanking | Blanking Control Signal | Total Capacitance |
|---|---|---|---|
| Number | Time | (B1 B0) | (femtofarads) |
| 3^{rd} or higher | 250 ns | 0 0 | 400 |
| valley | | | (C2 only) |
| 2^{nd} to 3^{rd} | 375 ns | 0 1 | 600 |
| valley | | | (C2 // C3) |
| 1^{st} valley | 500 ns | 1 1 | 800 |
| | | | (C2 // C3 // C4) |

With further reference to the example of FIG. 4A, ZVD circuit 305 receives the VSW signal, and is configured to generate a ZVD signal responsive to a valley included in the magnetizing ringing portion of the VSW signal reaching zero volts. The ZVD signal is provided to ZCD circuit 307. In this example, ZVD circuit 305 includes transistors MN1 and MN2, resistor R3, diode D3, capacitor CPAR, comparator 424, and a negative voltage supply-VT. Capacitor CPAR represents the parasitic capacitance between the SW node and the source terminal of transistor MN1, and diode D3 presents the body diode of transistor MN2. Although shown as distinct components, CPAR may be inherent in circuit 103, and D3 may be within MN2. Other ZVD configurations can be used. As further shown, each of transistors MN1 and MN2 is an n-type FET having its gate terminal coupled to ground, with transistor MN1 having its drain coupled to the switching terminal SW and its source coupled to the inverting input of comparator 424, and transistor MN2 having its drain coupled to the inverting input of comparator 424 and its source coupled to the ground terminal via resistor R3. Voltage supply-VT is coupled between ground and the non-inverting input of comparator 424. Transistor MN1 may be, for instance, a scaled replica of switching element 109, such as the example case where both MN1 and switching element 109 are GaN FETs. For instance, in some such examples, the width-to-length (W/L) ratio of switching element 109 is N times larger than the W/L ratio of FET MN1, wherein N is any integer greater than one (e.g., 800), and width W and length L are the channel parameters (actual dimensions of the current carrying area) of the respective transistors. Any scaling ratio suitable for a given application can be used. If needed, a voltage scaling circuit may be used as well, to reduce VSW to a low voltage domain (e.g., 5 volts). Transistor MN2 may be, for example, an n-type metal oxide semiconductor FET (e.g., 5 volt silicon NMOS FET, with silicon body diode D3). In an example, resistor R3 can be 50 K2, and voltage supply-VT can be −500 mv or just below ground potential.

In an example operation, when N*VOUT is less than or equal to VIN, the given valley doesn't reach ground (˜0 volts) and the negative slew leading in to a true valley runs for longer than leakage filter 408 (meaning that filter 408 will expire prior to the non-zero true valley being reached), thus allowing for proper valley declaration by AND-gate 410, as described below. However, when N*VOUT is greater than VIN, the valley bottoms into ground due to third quadrant conduction of transistor MN1. In such cases, the time for the negative slew leading into this true valley to reach ground can be comparable or otherwise closer to the time for the negative slew of a false valley within the leakage ringing portion of the VSW signal to run, thus making it difficult to distinguish between a true zero-voltage valley of the magnetizing ringing portion and a false valley of the leakage ringing portion. For instance, and with reference to the example of FIG. 4A, comparator 404 may indicate a true valley signal earlier than the expiry of leakage filter 408. In such an example case, without further action, the true zero-voltage valley will not be declared by AND-gate 410. ZVD circuit 305 (in conjunction with logic 414) may be used to help address this issue.

In more detail, to ascertain whether this valley is true or not, comparator 424 monitors the source of MN1, which will be negative due to third quadrant conduction of MN1 (MN1 reverse conducts when VSW goes negative), which in turn causes body diode D3 of MN2 to turn on (which drags the inverting input of comparator 424 below ground), which can be detected using comparator 424. When the source of MN1 becomes more negative than the negative voltage supply-VT, the output of comparator 424 goes high to indicate zero voltage has been reached. Additionally, the parasitic capacitor CPAR effectively also makes ZVD circuit 305 a slew detector, such that the ZVD signal at the output of comparator 424 may also toggle with valley or leakage ringing. However, such toggling can be distinguished, in an example. In particular, the respective outputs of comparator 424 and comparator 404 only agree when there is a real ZVS condition (zero voltage is detected). Otherwise, the outputs of comparators 404 and 424 are inverted with respect to each other. Thus, in an example, and as further described below, AND-gate 414 of ZCD circuit 307 is configured to detect when the outputs of comparators 404 and 424 are inverted (false valley), or the same (true valley).

With further reference to the example of FIG. 4A, ZCD circuit 307 receives the slew comparator signal of slew detect circuit 301, the blanking signal of adaptive blanking circuit 303, and the ZVD signal of ZVD circuit 305, and is configured to: blank out slew detections associated with the leakage reset portion of the VSW signal, responsive to the blanking signal; distinguish between a true valley included in the magnetizing ringing portion of the VSW signal and a false valley included in the leakage ringing portion of the VSW signal, responsive to the filter signal; and distinguish between a false valley included in the leakage ringing portion of the VSW signal and a true valley included in the magnetizing ringing portion of the VSW signal and that reaches zero volts. The ZCD signal provided by ZCD circuit 307 goes high to declare that a valley which has been detected is a true valley, and is otherwise low. Control circuit 105 can use such ZCD signals to conduct valley switching.

As further shown in the example of FIG. 4A, ZCD circuit 307 carries out such distinguishing between true and false valleys, and declaring of true valleys, using logic, and further includes leakage filter 408. The logic includes 2-input AND-gates 406, 410, and 414 (indicated with the & symbol) and a 2-input OR-gate 412 (indicated with the ≥1 symbol). An example implementation of leakage filter 408 is shown in FIG. 4C. As shown, leakage filter 408 includes capacitor C5, a current source IBIAS3, a Schmitt trigger 430, and transistor (switch) MN6. Capacitor C5 is coupled between the input of Schmitt trigger 430 and ground, and is switchable via transistor MN6 based on the valley detection signal from AND-gate 406. In this example, transistor MN6 is implemented with an NFET, but any suitable switching technology can be used, as described above with respect to MN3 through MN5. An example operation of leakage filter 408 is as follows.

When the valley detection signal from AND-gate 406 goes low (e.g., responsive to the slew comparator signal going low, thereby indicating the beginning of a negative slew toward a possible valley), transistor MN6 turns off (opens), thereby releasing the pull-down on the input node of Schmitt trigger 430 and allowing capacitor C5 to be charged with constant current source IBIAS3. When the voltage on the input node of Schmitt trigger 430 (and across capacitor C5) reaches the high threshold of Schmitt trigger 430 (VTH_SCHMITT_430), the filter signal at the output of Schmitt trigger 430 goes high and is provided to one of the inputs to AND-gate 410. Subsequently, when the valley detection signal from AND-gate 406 goes high (responsive to the blanking signal still being high and the slew comparator signal going high, because a valley was reached and positive slew commenced), transistor MN6 turns on (closes) thereby pulling the input node of Schmitt trigger 430 to a low state, which in turn causes the filter signal output of Schmitt trigger 430 to be low. The time from when the valley detection signal from AND-gate 406 goes low to when the output of Schmitt trigger 430 goes high corresponds to the leakage filter time. In this manner, the filter signal is a blanking signal that prevents AND-gate 410 from declaring valleys that have a negative slew that runs for less than the leakage filter time, such as false valleys of the leakage ringing portion of the VSW signal. The value of the leakage filter time can be determined as:

$$LEAKAGE FILTER TIME = C5\_CAPACITANCE * VTH\_SCHMITT \_ 430 / IBIAS 3. \qquad ( Equation 5 )$$

In one example case, the following values are used: C5 is 448 femtofarads, IBIAS3 is about 2 microamps, and the high threshold of Schmitt trigger 430 (VTH_SCHMITT_430) is 1.25 volts, which causes the filter signal to transition to its high state about 280 ns after the valley detection signal from AND-gate 406 goes low. More generally, the leakage filter time can be set to somewhere between the signal period of the leakage ringing portion and the signal period of the magnetization ringing portion. In more detail, an in accordance with some examples, the slowest frequency of the leakage ringing portion is about two times or more faster than the fastest frequency of the magnetization ringing portion, such that the shortest signal period of the magnetization ringing portion is about two times or more longer than the longest signal period of the leakage ringing portion. In this manner, the value of the leakage filter time can be set to be greater than the signal period of the leakage ringing portion but less than the signal period of the magnetization ringing portion. These signal periods may vary from one power converter configuration to the next, and may be determined empirically or theoretically (e.g., circuit modelling and analysis). Other examples may use different logic or otherwise be configured differently to provide similar functionality. Although leakage filter 408 provides a fixed leakage filter time in this example, it may be configured to provide an adjustable leakage filter time in other examples. For instance, the leakage filter time can be increased by configuring leakage filter 408 in a similar fashion as described with respect to the blanking time of variable blank delay 420 with reference to FIG. 4B, to selectively add more capacitance to increase the leakage filter time duration as needed to blank out leakage ringing.

With further reference to FIG. 4A, an example operation of ZCD circuit 307 is as follows. AND-gate 406 receives the slew comparator signal from comparator 404 at one of its inputs and the IPK-aware blanking signal from variable blank delay 420 at the other of its inputs, and generates a positive (high) valley detection signal at its output only when both of the inputs are high, and otherwise generates a negative (low) valley detection signal. In this manner, AND-gate 406 is configured to blank out the leakage reset portion of the VSW signal, responsive to the IPK-aware (and valley-aware) blanking signal, and to indicate valleys that occur after the reset blanking period.

Leakage filter 408 receives the valley detection signal at its input, and provides the filter signal at its output, as described above. AND-gate 410 receives the valley detection signal from AND-gate 406 at one of its inputs and the filter signal from leakage filter 408 at the other of its inputs, and generates a positive (high) valley detection signal at its output when both of the inputs are high and otherwise generates a negative (low) valley detection signal. In this manner, AND-gate 410 is configured to blank out the leakage ringing portion of the VSW signal, responsive to the filter signal, thereby distinguishing any true valley detections generated by AND-gate 406 from any false valley detections generated by AND-gate 406 as a result of the leakage ringing portion of the VSW signal.

AND-gate 414 receives the valley detection signal from AND-gate 406 at one of its inputs and the ZVD signal from comparator 424 at the other of its inputs, and generates a positive (high) valley detection signal at its output when both of the inputs are high and otherwise generates a negative (low) valley detection signal. In this manner, AND-gate 414 is configured to distinguish false valleys of the leakage ringing portion of the VSW signal from a true valley that reaches zero volts prior to expiry of leakage filter 408.

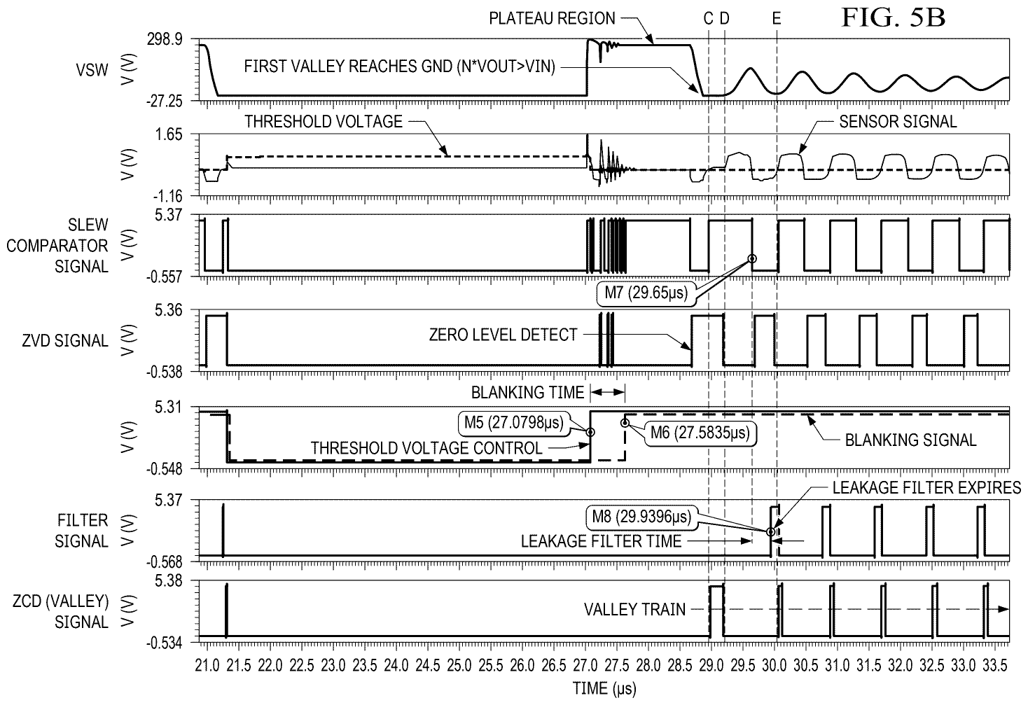

OR-gate 412 receives the output from AND-gate 410 at one of its inputs and the output of AND-gate 414 at the other of its inputs, and generates a positive (high) valley detection signal at its output when one or both of the inputs are high and otherwise generates a negative (low) valley detection signal. In this manner, OR-gate 412 is configured to declare one or more true valleys included in the magnetizing ringing portion of the VSW signal, responsive to input from AND-gate 410 and/or AND-gate 414. As further shown in the example of FIG. 5A, the first valley reaches about 320 volts.

FIG. 5A illustrates plots of signals generated by the system of FIG. 1 when N*VOUT is less than or equal to VIN, in an example. Reference to FIG. 4A may be made to further facilitate understanding, and the above relevant description is equally applicable here. The first (topmost) plot of FIG. 5A is the VSW signal, from the switching node SW of a power converter, such as power converter 100. In this example, the VSW signal ranges between about 0 volts to about 600 volts. As shown on the time scale axis, the TON and TOFF portions of the depicted switching cycle start at about 25.1 us and about 27 μs, respectively. Also, the leakage reset blanking period ends about 27.6 μs (designated by the dashed line labeled A) and corresponds to the leakage reset portion of the VSW signal and possibly some of the leakage ringing portion of the VSW signal. Also, the plateau region (which may also include some of leakage ringing portion) extends from that point A to about 33 μs, and the first true valley of the magnetizing ringing portion of the VSW signal occurs at about 33.8 μs (designated by the dashed line labelled B) and reaches about 320 volts. The subsequent valleys of the magnetizing ringing portion are progressively shallower. Switching may occur at any of the true valleys.

With further reference to FIG. 5A, the second plot from top shows the threshold voltage at the inverting input of comparator 404. Recall from above that when the VDRV signal goes high (to initiate the TON portion of the VSW signal, of the next switching cycle), logic 416 of adaptive blanking circuit 303 is reset and the threshold voltage control signal at the Q output of logic 416 goes low (as shown in the fifth plot from top of FIG. 5A), which in turn causes switch S1 to close and switch S2 to open, such that the threshold voltage at the inverting input of comparator 404 transitions from its low value to its high value (voltage source V1), which in the example of FIG. 5A are 0 volts and 600 mv, respectively. Further recall from above that when the VDRV signal goes low (to initiate the TOFF portion of the VSW signal, of the current switching cycle), logic 416 becomes set and waits for the next positive edge on its clock input, which in this example corresponds to the first falling edge of the sensor signal, as inverted by inverter 422. In more detail, and as shown in the third plot from top of the example of FIG. 5A, this first falling edge of the sensor signal occurs at around 27.1 us just after the first rising edge of the sensor signal, which is the response of sensor 402 to the positive slew SL1 (FIG. 2) of the VSW signal, at the onset of the leakage reset portion. This falling edge of the sensor signal is converted to a positive edge by inverter 422, and this positive going edge is received at the clock input of logic 416. This positive going edge causes the threshold voltage control signal at the Q output of logic 416 to transition from low to high (as shown in fifth plot from top, also at about 27.1 μs), which in turn causes switch S2 to close and switch S1 to open, thereby causing the threshold voltage to transition from its high value of about 600 mv to its low value of about 0 volts (as shown in the second plot from top, also at about 27.1 μs). As further shown in the fifth plot from top of FIG. 5A, the high state of the threshold voltage control signal is held until VDRV goes high again (to initiate the next switching cycle), which resets logic 416 and thus causes the threshold voltage control signal to go low, which in turn causes switch S1 to close and switch S2 to open, thus causing the threshold voltage to transition from its low value of 0 volts to its high value of 600 mv (such as shown in second plot from top).

With further reference to FIG. 5A, the third plot from top shows the sensor signal provided by sensor 402, to the non-inverting input of comparator 404. As shown, the capacitor C1 causes sensor signal to: slew to or otherwise towards a low state responsive to falling edges of the VSW signal; slew to or otherwise towards a high state responsive to rising edges of the VSW signal; and remain at a middle state responsive to flat (non-slewing) portions of the VSW signal. In this example, the low state is about −0.5, the high state is about 0.7 volts (because of clamp D1−D2), and the middle state is in the range of about 50 mv to 100 mv (just above ground potential, in accordance with IBIAS1 and resistor R1, as described above).

With further reference to FIG. 5A, the fourth plot from top shows the slew comparator signal provided by comparator 404. As shown, if the voltage of the sensor signal at the non-inverting input of comparator 404 minus the threshold voltage at the inverting input of comparator 404 is greater than about 0 volts, then the slew comparator signal provided by comparator 404 is high; and if the voltage of the sensor signal at the non-inverting input of comparator 404 minus the threshold voltage at the inverting input of comparator 404 is less than or equal to 0 volts, then the slew comparator signal provided by comparator 404 is low. As can further be seen, during the plateau region of the VSW signal after the more aggressive leakage ringing settles (at about the dashed line A), the slew comparator signal provided by comparator 404 is high until the negative slew of the first valley of the magnetizing ringing portion of the VSW signal commences. This is because the threshold voltage at the inverting input of comparator 404 is set to ground potential, and the sensor signal during the plateau region is biased just above ground potential. Responsive to the negative slew, the slew comparator signal provided by comparator 404 then toggles from high to low and remains low until the valley is reached and opposite (positive) slew begins, at which point the slew comparator signal toggles from low to high and remains high until the peak is reached and opposite (negative) slew begins. In this manner, the true valleys of the magnetizing ringing portion may be identified by the rising edge of the slew comparator signal. This toggling of the slew comparator signal may repeat until either control circuit 105 initiates the next switching cycle (TON) or resonance of the TDEAD period of the switching cycle ceases or otherwise diminishes to a non-triggering level.

With further reference to FIG. 5A, the sixth plot from top shows the blanking signal provided by Schmitt trigger 426. As shown, when the threshold voltage control signal (fifth plot from top) from the Q output of logic 416 goes low (responsive to the VDRV signal going high during the TON portion of the VSW signal), the blanking signal provided by Schmitt trigger 426 goes low. Subsequently, when the threshold voltage control signal from the Q output of logic 416 goes high (responsive to the VDRV signal going low during the TOFF portion of the VSW signal), the timed blanking period is initiated, as described above. When the voltage on the input node of Schmitt trigger 426 reaches the high threshold of Schmitt trigger 426, the blanking signal provided by Schmitt trigger 426 goes high and remains high until the onset of the next switching cycle. As further shown in sixth plot from top of FIG. 5A, the duration of the low state of the blanking signal that occurs prior to the threshold voltage control signal (fifth plot) going high can be ignored, as it corresponds to the TON portion of the VSW signal (no valley switching takes place). However, the duration of the low state of the blanking signal that occurs after the threshold voltage control signal goes high corresponds to the actual blanking time (as labeled in FIG. 5A), and can be determined as described above. In this example of FIG. 5A, the blanking time is about 504 ns (M2−M1). Such a blanking time can be provided as described above with reference to FIG. 4B (e.g., by switching in capacitors C2, C3, and C4).

With further reference to FIG. 5A, the seventh plot from top shows the filter signal provided by Schmitt trigger 430. As a preliminary matter, note that the valley detection signal at the output of AND-gate 406 largely tracks the slew comparator signal on the input of AND-gate 406, assuming the blanking signal is high and allowing for some propagation delay. When the valley detection signal from AND-gate 406 is high (responsive to the slew comparator signal and the blanking signal both being high), the filter signal output of Schmitt trigger 430 is low, as described above. Subsequently, when the valley detection signal from AND-gate 406 goes low (e.g., responsive to the slew comparator signal going low, thereby indicating the beginning of a negative slew toward a possible valley), the pull-down on the input node of Schmitt trigger 430 is released and the leakage filter time period is initiated, as further described above. The filter signal at the output of Schmitt trigger 430 goes high after the leakage filter time expires, and remains high until the valley detection signal from AND-gate 406 goes high again (e.g., responsive to the slew comparator signal going high again, thereby indicating the beginning of a positive slew), which in turn causes the filter signal output of Schmitt trigger 430 to go low, and the process repeats for subsequent valleys. Thus, the leakage filter time runs from when the valley detection signal from AND-gate 406 goes low to when the filter signal at the output of Schmitt trigger 430 goes high, and in this example is about 290 ns (M4−M3). Such a leakage filter time can be provided as described above with reference to FIG. 4C.

With further reference to FIG. 5A, the eighth plot from top shows the ZCD signal provided by OR-gate 412. As a preliminary matter, note that the output of AND-gate 410 largely tracks the slew comparator signal on the input of AND-gate 406, assuming the blanking signal is high, the filter signal is high, and allowing for some propagation delay. Further note that in this example of FIG. 5A, the ZVD signal is low, as none of the valleys have reached zero volts. So the input to OR-gate 412 from AND-gate 414 will be low. As shown, the ZCD signal at the output of OR-gate 412 is low when the outputs from AND-gate 410 and AND-gate 414 are both low. However, as further shown, when the blanking signal and the filter signal are both high, and the slew comparator signal transitions from low to high (indicative of a valley), the ZCD signal at the output of OR-gate 412 transitions from low to high, thereby declaring or otherwise signaling a valley. This declaration is repeated for each subsequent occurrence of the blanking signal and the filter signal both being high along with the slew comparator signal transitioning high (indicative of the next valley), so as to provide a set of ZCD signals, also referred to as a valley train, which control circuit 105 can use for switching.

In a similar fashion to FIG. 5A, FIG. 5B illustrates plots of signals generated by the system of FIG. 1, except that FIG. 5B shows the case when N*VOUT is greater than VIN, in an example. Reference to FIG. 4A may be made to further facilitate understanding, and the above relevant description is equally applicable here. The first (topmost) plot of FIG. 5B is the VSW signal, from the switching node SW of a power converter, such as power converter 100. In this example, the VSW signal ranges between about 0 volts to about 265 volts. As shown on the time scale axis, the TON and TOFF portions of the depicted switching cycle start at about 21.2 μs and around 27.1 μs, respectively. Also, in this example, the first true valley of the magnetizing ringing portion of the VSW signal occurs at around 29 μs and reaches ground potential (designated by the dashed lines labelled C and D). Such a situation occurs when N*VOUT is greater than VIN. In more detail, and as best shown in FIG. 2, VIN is effectively the average of the VSW signal, and N*VOUT is the voltage in the plateau region of the VSW signal relative to VIN. In the example of FIG. 5B, the magnitude of N*VOUT is greater than the magnitude of VIN. The subsequent valleys of the magnetizing ringing portion are progressively shallower, and do not reach ground potential in this example, including the second true valley (designated by the dashed line labelled E). In other examples, the second, third, etc. true valley(s) may also reach ground potential. Switching may occur at any of the true valleys.

With further reference to FIG. 5B, the second and third plots from top are overlaid on each other and show the threshold voltage at the inverting input of comparator 404 and the sensor signal at the non-inverting input of comparator 404. The above relevant description of the second and third plots from the top of FIG. 5A is equally applicable here, including the description with respect to circuit functionality, the values of the threshold voltages (e.g., 0 volts and 600 mv), the first falling edge of the sensor signal occurring at around 27.1 μs, the threshold voltage responsively transitioning from its high value (e.g., about 600 mv) to its low value (e.g., about 0 volts), and the low, middle, and high states of the sensor signal (e.g., −0.5 volts, 50 mv to 100 mv, and 0.7 volts). Other examples may be configured differently and have different parameter values and timing, but still provide similar functionality.

With further reference to FIG. 5B, the fourth plot from top shows the slew comparator signal provided by comparator 404. The above relevant description of the fourth plot from the top of FIG. 5A is equally applicable here, including the description with respect to circuit functionality. Other examples may be configured differently and have different parameter values and timing, but still provide similar functionality. As shown in the example of FIG. 5B, the slew comparator signal provided by comparator 404 is high during the plateau region until the negative slew of the first valley commences, at which point the slew comparator signal toggles from high to low and remains low until the valley is reached which in this example is at 0 volts (designated with dashed line labelled C), at which point the slew comparator signal toggles from low to high and remains high until the next peak is reached and opposite (negative) slew begins. Like the example of FIG. 5A, valleys may be identified by the rising edge of the slew comparator signal, and the toggling of the slew comparator signal may repeat until either control circuit 105 initiates the next switching cycle (TON) or resonance of the TDEAD period of the switching cycle ceases or otherwise diminishes to a non-triggering level.

With further reference to FIG. 5B, the fifth plot from top shows the ZVD signal provided by comparator 424. In the example of FIG. 5A, none of the valleys reached ground potential, as described above, so the ZVD signal in that examples would remain in its low state. In the example of FIG. 5B, however, the first valley reaches ground potential. As further described above, ZVD circuit 305 also acts as a slew detector, due to CPAR. In more detail, and as shown in the example of FIG. 5B, the ZVD signal will go high responsive to negative slew of the VSW signal and low responsive to positive slew. In addition, the ZVD signal will also go high when zero volts is detected. As described above, the condition of interest here is when both the ZVD signal and the slew comparator signal are high at the same time, as detected by AND-gate 414. In contrast, occurrence of the ZVD signal being high when the slew comparator signal is low can be ignored. As shown in the example FIG. 5B, the ZVD signal and the slew comparator signal are high at the same time from about 28.9 μs to about 29.2 μs (designated with dashed lines labelled C and D). This is the only time period in this example when that condition is met, and AND-gate 414 will accordingly declare a true valley.

With further reference to FIG. 5B, the sixth and seventh plots from top are overlaid on each other and show the threshold voltage control signal provided by adaptive blanking circuit 303 and the blanking signal provided by Schmitt trigger 426. The above relevant description of the threshold voltage control signal and the blanking signal with respect to FIG. 5A is equally applicable here. As described above, the duration of the low state of the blanking signal that occurs prior to the threshold voltage control signal going high can be ignored, as it corresponds to the TON portion of the VSW signal (no valley switching takes place). However, the duration of the low state of the blanking signal that occurs after the threshold voltage control signal goes high corresponds to the actual blanking time (as labeled in FIG. 5B), and can be determined as described above. In this example of FIG. 5B, the blanking time is about 504 ns (M6−M5). Again, such a blanking time can be provided as described above with reference to FIG. 4B (e.g., by switching in capacitors C2, C3, and C4).

With further reference to FIG. 5B, the eighth plot from top shows the filter signal provided by Schmitt trigger 430. The above relevant description of the filter signal and leakage filter time with respect to FIG. 5A is equally applicable here. As described above, the leakage filter time runs from when the valley detection signal from AND-gate 406 goes low (e.g., responsive to the slew comparator signal going low, thereby indicating the beginning of a negative slew toward a possible valley) to when the filter signal at the output of Schmitt trigger 430 goes high, and in this example is about 290 ns (M8−M7). Again, such a leakage filter time can be provided as described above with reference to FIG. 4C.

With further reference to FIG. 5B, the bottom plot shows the ZCD signal provided by OR-gate 412. The above relevant description of the filter signal and leakage filter time with respect to FIG. 5A is equally applicable here. Unlike the example of FIG. 5A where the ZVD signal is low (because none of the valleys reached zero volts), the first valley of FIG. 5B reaches ground and the ZVD signal is accordingly high. So the input to OR-gate 412 from AND-gate 414 will be high. As further shown in the example of FIG. 5B, the ZCD signal at the output of OR-gate 412 is low when the outputs from AND-gate 410 and AND-gate 414 are both low. However, as further shown in FIG. 5B, when the blanking signal and either of the filter signal or the ZVD signal are both high, and the slew comparator signal transitions from low to high (indicative of a valley), the ZCD signal at the output of OR-gate 412 transitions from low to high, thereby declaring or otherwise signaling a valley. This declaration is repeated for each subsequent occurrence of the blanking signal and the filter signal (or the ZVD signal) being high along with the slew comparator signal transitioning high (indicative of the next valley), so as to provide a set of ZCD signals (valley train) which control circuit 105 can use for switching.

### Methodology

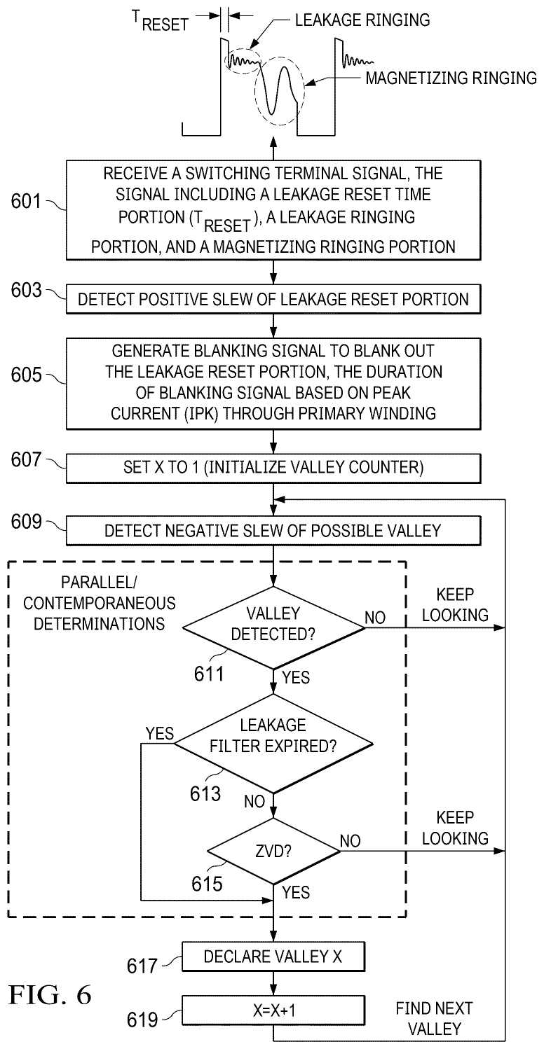

FIG. 6 illustrates a flow chart of a method for valley sensing in a flyback power converter, in an example. The methodology can be carried out, for example, by the system 100 shown in FIG. 1, although other systems capable of valley switching using the VSW signal at the switching node of the given system.

At 601, the method includes receiving a switching terminal signal (VSW). As shown, the signal includes a leakage reset time portion (TRESET), a leakage ringing portion, and a magnetizing ringing portion. The valleys to be switched on are in the magnetizing ringing portion.

At 603, the method continues with detecting positive slew of the leakage reset portion (designated as SL1, at the beginning of the TDEMAG portion, as shown in FIG. 2). As described above with respect to FIGS. 4A, 5A, and 5B, this positive slew detection may be carried out, for example, by sensor 402 and comparator 404 of slew detect circuit 301, when the threshold voltage at the inverting input of comparator 404 is set to the value of voltage source V1, by operation adaptive blanking circuit 303 and responsive to VDRV. The method continues at 605, with generating a blanking signal configured to blank out the leakage reset portion. As described above, the duration of the leakage reset blanking period configured into blanking signal may be based on the peak current (IPK) through primary winding, and the valley number that is to be switched on, so as to provide an IPK-aware (and valley-aware) blanking time. As further described above with respect to FIGS. 4A, 4B, 5A, and 5B, this blanking signal generation may be carried out, for example, by the variable blank delay 420 of adaptive blanking circuit 303, responsive to the threshold voltage control signal from logic 416 and the blanking control from control circuit 105. As further shown in FIG. 6, the detecting at 603 and the generating at 605 can be used to bypass or otherwise ignore the TRESET portion of the switching terminal signal. The blanking signal from variable delay 420 is then used in conjunction with the slew comparator signal from comparator 404 via AND-gate 406 to generate valley detection signals, after the leakage reset blanking period has ended.

With the leakage reset (TRESET) portion of the switching terminal signal blanked out, the method continues with initializing, at 607, a valley counter (e.g., setting X equal to 1), and detecting, at 609, the negative slew of possible valley(s). In more detail, and as further described above, one or more valleys may occur after the blanked TRESET portion of the switching terminal signal, and those valleys may include false valleys (e.g., valleys in the leakage ringing portion) and true valleys (e.g., valley in the magnetizing ringing portion). The valleys can be identified, for instance, when the negative slew detected at 609 ceases (e.g., when the rate of change goes to zero, such as when zero voltage is reached or when negative slew transitions to positive slew). As further described above with respect to FIGS. 4A, 5A, and 5B, negative slew detection may be carried out, for example, by sensor 402 and comparator 404 of slew detect circuit 301, when the threshold voltage at the inverting input of comparator 404 is set to ground potential, by operation adaptive blanking circuit 303 and responsive to VDRV. In such an example case, the slew comparator signal generated by comparator 404 transitions from high to low when negative slew begins.

The method continues at 611, with determining if a valley is detected. As described above, logic such as AND-gate 406 can be used in conjunction with slew detect circuit 301 to detect if a valley occurred. In more detail, and with the blanking signal from variable blank delay 420 still high (because the leakage reset blanking period ended), the slew comparator signal from comparator 404 will remain low as the negative slew detected at 609 continues. This means no valley is yet detected at 611. In such case, the method is configured to keep looking for valleys by returning to 609, where monitoring for negative slew continues. Eventually, the slew comparator signal from comparator 404 transitions from low to high, responsive to the negative slew detected at 609 changing to zero voltage (no slew) or positive slew thus indicating occurrence of a valley. This causes the valley detection signal generated by AND-gate 406 to go high, which means a valley has been detected at 611.

At the time a valley is detected at 611, the method further includes, at 613, determining if a leakage filter is expired. As explained above, the leakage filter is configured to ensure that the negative slew of a detected valley runs for a sufficient amount of time, because a false valley in the leakage ringing portion may will be detected prior to expiry of the leakage filter, whereas a true valley in the magnetizing ringing portion will be detected after expiry of the leakage filter. As further described above with respect to FIGS. 4A, 5A, and 5B, this determining if the leakage filter expired may be carried out, for example, by logic such as AND-gate 410 of ZCD circuit 301. If the leakage filter at 613 has expired by the time the valley detection signal from AND-gate 406 transitions from low to high (indicating a positive valley determination at 611), the filter signal from leakage filter from 408 will also be high at that time, thus causing AND-gate 410 to be high, thereby allowing a positive declaration for that valley. In such a case, the method continues at 617, with declaring the valley detected at 611 to be a true valley. In this example, the declared valley is assigned a number X (e.g., 1^{st} valley, 2^{nd} valley, etc.), and may be one of a number of true valleys that are declared. This declaration at 617 can be carried out, for instance, by logic such as OR-gate 412, which receives the high signal generated by AND-gate 410, which in turn causes the ZCD signal at the output of OR-gate 412 to go high. The ZCD signal can be used by control circuit 105 in a valley switching control scheme.

However, if the valley detection signal from AND-gate 406 transitions from low to high as described above (indicating a positive valley determination at 611), but the leakage filter at 613 has not expired at that time, then the filter signal from leakage filter from 408 will be low, thus causing AND-gate 410 to be low, thereby potentially suppressing a positive declaration for that valley. In such a case, the method may perform another determination to see if the detected valley is nonetheless a true valley for other reasons. In more detail, and with further reference to FIG. 6, the method continues at 615 with determining if the detected valley that occurred prior to expiry of the leakage filter reached zero voltage (ZVD condition). If a ZVD condition was not achieved by the valley detected at 611, the method is configured to keep looking for valleys by returning to 609, where monitoring for negative slew continues. If, however, a ZVD condition was achieved by the valley detected at 611, the method continues at 617, with declaring the valley detected at 611 to be a true valley.

As further described above with respect to FIGS. 4A, 5A, and 5B, the determining at 615 if the valley detected at 611 satisfies a ZVD condition can be carried out, for example, by logic such as AND-gate 414 in conjunction with ZVD circuit 305. Also, the declaration at 617 can be carried out, for instance, by logic such as OR-gate 412. For instance, in some such examples, if the ZVD condition indicated by ZVD circuit 305 is true when the valley detection signal from AND-gate 406 is high, then the output of AND-gate 414 will be high, thereby indicating the valley detected at 611 is a true valley. The OR-gate 412 receives the high signal generated by AND-gate 414, which in turn causes the ZCD signal at the output of OR-gate 412 to go high. If, however, the ZVD condition indicated by ZVD circuit 305 is false while the valley detection signal from AND-gate 406 is high, then the output of AND-gate 414 will be low, thereby indicating the valley detected at 611 is a false valley. The OR-gate 412 receives the low signal generated by AND-gate 414, which in turn causes the ZCD signal at the output of OR-gate 412 to go low (assuming the output of AND-gate 410 is also low). As described above, the ZCD signals can be used by control circuit 105 in a valley switching control scheme. With further reference to FIG. 6, after a true valley is declared at 617, the method continues with incrementing the valley counter (X=X+1) and is configured to find the next valley by returning to 609, where monitoring for negative slew continues.

### Power System

FIG. 7 illustrates a block diagram of a system 700 including a flyback power converter configured for valley sensing without using an auxiliary winding, in an example. As shown, system 700 includes a snubber 710, a flyback transformer 711, an EMI filter 715, a rectifier 717, an AC sense circuit 718, a synchronous rectification transistor QSR, a synchronous rectification (SR) controller 720, an output capacitor COUT, an output transistor QOUT, a port 722, a feedback circuit 713 that includes USB-PD controller 724 and optocoupler 726, and a controller 728 that includes IC 101. In this example, system 700 converts an AC input voltage (VAC) to a DC input voltage (VIN) which is in turn converted by the flyback power converter to a regulated DC output voltage (VOUT). VOUT is in turn coupled to port 722 to which a load may be coupled. In other examples, the DC input voltage VIN may be sourced directly, rather than derived from AC input voltage VAC.

EMI filter 715 removes unwanted noise from the line voltage, rectifier 717 rectifies the AC input, and AC sense circuit 718 allows controller 728 to detect if VAC is present. Any suitable EMI filtering, rectifier, and sensing circuitry can be used. Other examples may have VIN directly applied rather than derived from an AC source as shown. In such cases, system 700 may not include VAC, EMI filter 115, rectifier 117, or AC sense circuit 718. Transformer 711 allows for energy storage, energy transfer, and galvanic isolation between the input VIN and output VOUT. Any suitable flyback transformer may be used. In this example, flyback transformer 111 does not include any auxiliary winding used for valley sensing. Other examples may include one or more auxiliary windings, for instance, to provide another option for carrying out valley detection, and/or for providing overvoltage protection and/or a bias supply. Snubber 710 provides clamp voltage VCLAMP, and may be implemented with any suitable snubber circuit. QSR and SR controller 720 collectively provide a synchronous rectifier (instead of DOUT in FIG. 1), which can be used to improve efficiency for flyback topologies.

Capacitor COUT operates in a similar fashion as described above, with reference to FIG. 1. In this example, port 722 is a type-C USB port, and controller 724 is a USB-PD controller. Other universal and proprietary port technologies may be used. QOUT can be used, for example, to disconnect the load, responsive to control from controller 724 if an over-voltage condition or high current condition is detected. Optocoupler 726 provides feedback voltage VFB from the secondary to primary, in an isolated fashion. Controller 728 may be implemented with any suitable flyback converter control circuitry, and is further configured with IC 101, so that controller 728 is able to carry out valley switching based on the VSW signal received at the SW terminal and without the use of an auxiliary winding, as variously described herein. In this example, controller 728 may further include a switching element coupled between the SW and ground terminals, and may also include a sense circuit (such as shown in FIG. 1 with respect to 109 and 108). In other examples, the switching element (and sense circuit, if present) may be implemented external to controller 728.

### FURTHER EXAMPLES

Example 1 is a device including: a first logic circuit (e.g., 406) configured to blank out a leakage reset portion of a switching terminal signal, responsive to a first blanking signal; a second logic circuit (e.g., 410) configured to blank out a leakage ringing portion of the switching terminal signal, responsive to a second blanking signal; a third logic circuit (e.g., 414) configured to distinguish the leakage ringing portion of the switching terminal signal from a valley that reaches zero volts, responsive to a zero voltage detection (ZVD) signal, the valley included in a magnetizing ringing portion of the switching terminal signal; and a fourth logic circuit (e.g., 412) configured to declare one or more valleys included in the magnetizing ringing portion of the switching terminal signal, responsive to input from the second and third logic circuits.

Example 2 includes the device of Example 1, and further includes a slew detect circuit (e.g., 301) configured to detect slew of the switching terminal signal.

Example 3 includes the device of Example 2, and further includes: a first threshold voltage (e.g., V1) that allows the slew detect circuit to operate as a positive slew detector; and a second threshold voltage (e.g., ground) that allows the slew detect circuit to operate as a negative slew detector.

Example 4 includes the device of any one of Examples 1 through 3, wherein: the first logic circuit comprises an AND-gate; the second logic circuit comprises an AND-gate; the third logic circuit comprises an AND-gate; and the fourth logic circuit comprises an OR-gate.

Example 5 includes the device of any one of Examples 1 through 3, wherein: the first logic circuit is an AND-gate; the second logic circuit is an AND-gate; the third logic circuit is an AND-gate; and the fourth logic circuit is an OR-gate.

Example 6 includes the device of any one of Examples 1 through 5, wherein the first blanking signal has a duration that varies based on a peak current of the power converter.

Example 7 includes the device of any one of Examples 1 through 6, wherein the second blanking signal has a fixed duration based on a signal period of the leakage ringing portion.

Example 8 includes the device of any one of Examples 1 through 7, and further includes a zero voltage detect (ZVD) circuit configured to detect the valley that reaches zero volts, and generate the ZVD signal.

Example 9 is a system that includes: the device of any one of Examples 1 through 8; an input voltage terminal; an output voltage terminal; a switching terminal at which the switching terminal signal is provided; a feedback terminal; a transformer having a primary winding and a secondary winding, the primary winding coupled between the input voltage terminal and the switching terminal; and a feedback circuit coupled between the output voltage terminal and the feedback terminal.

Example 10 is a device that includes: a first circuit (e.g., 301) configured to receive a switching terminal signal of a flyback power converter, the first circuit further configured to detect a leakage reset portion of the switching terminal signal, and to detect one or more valleys of the switching terminal signal; a second circuit (e.g., 303) configured to generate a blanking signal that at least partially corresponds to the leakage reset portion of the switching terminal signal; and a third circuit (e.g., 307) configured to receive detections of the first circuit, as well as the blanking signal of the second circuit, the third circuit further configured to blank out the leakage reset portion of a switching terminal signal, responsive to the blanking signal, and distinguish between a valley included in a magnetizing ringing portion of the switching terminal signal and a valley included in a leakage ringing portion of the switching terminal signal.

Example 11 includes the device of Example 10, and further includes: a fourth circuit (e.g., 305) configured to generate a zero voltage detection (ZVD) signal responsive to a valley included in a magnetizing ringing portion of the switching terminal signal reaching zero volts; wherein the third circuit is further configured to receive the ZVD signal of the fourth circuit, and to distinguish between a zero voltage valley included in a magnetizing ringing portion of the switching terminal signal and a valley included in a leakage ringing portion of the switching terminal signal.

Example 12 includes the device of Example 11, wherein the fourth circuit includes: a comparator having a ZVD signal output coupled to the third circuit, the comparator further having a first comparator input coupled to a switching terminal input via a biasing circuit, and a second comparator input coupled to a negative voltage reference.

Example 13 includes the device of any one of Examples 10 through 12, wherein the third circuit is configured to assert a zero current detection (ZCD) signal responsive to first and second conditions in the alternative, the first condition including a valley detection after a negative slew period that persists for at least a pre-set time period, and the second condition including a valley detection when the valley reaches zero volts.

Example 14 includes the device of Example 13, wherein a frequency of the leakage ringing portion is higher than a frequency of the magnetizing ringing portion, and the pre-set time period is greater than a signal period associated with the leakage ringing portion.

Example 15 includes the device of any one of Examples 10 through 14, wherein the first circuit includes: a switching terminal input; a comparator having first and second comparator inputs and a comparator output; and a sensor circuit coupled between the switching terminal and the first comparator input, the sensor circuit including a high-pass filter and a voltage clamp.

Example 16 includes the device of Example 15, wherein the second comparator input is switchably coupled to each of a first threshold voltage and a second threshold voltage, and wherein the first threshold voltage allows the first circuit to operate as a positive slew detector configured to detect the leakage reset portion of the switching terminal signal, and the second threshold voltage allows the first circuit to operate as a negative slew detector configured to detect the one or more valleys of the switching terminal signal.

Example 17 includes the device of any one of Examples 10 through 16, wherein the second circuit includes: a variable blank delay circuit having a blanking signal output coupled to the third circuit, the variable blank delay circuit further including a blanking control input; a flip-flop coupled having a clocking input coupled to an output of the first circuit, and having a flip-flop output coupled to the variable blank delay circuit; a first switch coupled between a first threshold voltage terminal and a threshold voltage input of the first circuit, the first switch having a control input coupled to the flip-flop output; and a second switch coupled between the second threshold voltage terminal and the threshold voltage input of the first circuit, the second switch having a control input coupled to the flip-flop output via an inverter.

Example 18 includes the device of Example 17, wherein the inverter is a first inverter, and the second circuit further comprises a second inverter coupled between the flip-flop clocking input and the first circuit output.

Example 19 includes the device of Example 17 or 18, wherein the second circuit further includes a drive signal input, the drive signal input coupled to a reset input of the flip-flop.

Example 20 is a device, which includes: a slew detect circuit having a switching terminal input, and further including a comparator having a threshold voltage input and a comparator output; a zero current detect circuit having an input coupled to the comparator output, and further including a blanking signal input and a zero current detection (ZCD) signal output; a first threshold voltage switchably coupled to the threshold voltage input of the comparator; a second threshold voltage switchably coupled to the threshold voltage input of the comparator; and an adaptive blanking circuit having a clocking input terminal coupled to the comparator output, and further including a blanking signal output, the blanking signal output coupled to the blanking signal input of the zero current detect circuit.

Example 21 includes the device of Example 20, wherein the zero current detect circuit further includes a zero voltage detect (ZVD) signal input, and the device further includes: a zero voltage detect circuit having an input coupled to the switching terminal input of the slew detect circuit, and an output coupled to the ZVD signal input of the zero current detect circuit.

Example 22 includes the device of Example 21, wherein the comparator of the slew detect circuit is a first comparator, and the zero voltage detect circuit further includes: a second comparator having an output coupled to the output of the zero voltage detect circuit, the second comparator further having a first input coupled to the switching terminal input of the slew circuit via a biasing circuit, and a second input coupled to a negative voltage reference.

Example 23 includes the device of any one of Examples 20 through 22, wherein the adaptive blanking circuit further includes a variable blank delay circuit having an output coupled to the blanking signal output, the variable blank delay circuit further including a blanking control input.

Example 24 includes the device of Example 23, wherein the adaptive blanking circuit further includes: a flip-flop coupled to the clocking input, and having a flip-flop output coupled to the variable blank delay circuit; a first switch coupled between the first threshold voltage and the threshold voltage input of the comparator, the first switch having a control input coupled to the flip-flop output; and a second switch coupled between the second threshold voltage and the threshold voltage input of the comparator, the second switch having a control input coupled to the flip-flop output via an inverter.

Example 25 includes the device of Example 24, wherein the inverter is a first inverter, and the flip-flop is coupled to the clocking input via a second inverter.

Example 26 includes the device of any one of Examples 20 through 25, wherein the adaptive blanking circuit further includes a drive signal input, the drive signal input coupled to a reset input of the flip-flop.

Example 27 includes the device of any one of Examples 20 through 26, wherein the threshold voltage input of the comparator is a first input of the comparator, and the slew detect circuit further includes: a sensor circuit coupled between the switching terminal input and a second input of the comparator, the sensor circuit including a resistor-capacitor filter and a voltage clamp; and a current source coupled to between a power supply terminal and the second input of the comparator.

Example 28 includes the device of any one of Examples 20 through 27, wherein the zero current detect circuit further includes: a first AND-gate having first and second inputs coupled to the comparator output and the blanking signal input, respectively, and an output; a leakage filter having an input coupled to the first AND-gate output, and an output; and a second AND-gate having first and second inputs coupled to the first AND-gate output and the leakage filter output, respectively.

Example 29 includes the device of Example 28, and further includes: a zero voltage detect circuit having an input coupled to the switching terminal input of the slew detect circuit, and an output. In some such examples, the zero current detect circuit further includes: a third AND-gate having first and second inputs coupled to the first AND-gate output and the zero voltage detect circuit output, respectively, and an output; and an OR-gate having first and second inputs coupled to the second AND-gate output and the third AND-gate output, respectively, and an output coupled to the ZCD signal output.

Example 30 is a method, which includes: receiving a switching terminal signal, the switching terminal signal including a leakage reset portion, a leakage ringing portion, and a magnetizing ringing portion; detecting positive slew of the leakage reset portion; generating a blanking signal to blank out the leakage reset portion; and detecting a negative slew of the switching terminal signal. Responsive to a valley being detected in the switching terminal signal, the method further includes: declaring a valley if a leakage filter has expired, the leakage filter having a period that is longer than a period of the leakage ringing portion of the switching terminal signal; or declaring a valley if the detected valley has reached zero volts.

Example 31 includes the method of Example 30, wherein responsive to the detected valley not having reached zero volts, the method includes not declaring a valley.

Example 32 includes the method of Example 30 or 31, wherein the duration of the blanking signal is based on a peak current through a primary winding of a flyback converter.

Example 33 includes the method of any one of Examples 30 through 32, and further includes: repeating the method from detecting a negative slew of the switching terminal signal and onward, for one or more additional valleys included in the magnetizing ringing portion of the switching terminal signal.

Example 34 includes the method of any one of Examples 30 through 33, wherein declaring a valley if the leakage filter has expired includes: determining, prior to declaring a valley, if the leakage filter has expired; and responsive to the leakage filter having expired, declaring a valley.

Example 35 includes the method of any one of Examples 30 through 34, wherein declaring a valley if the detected valley has reached zero volts includes: determining if the detected valley reached zero volts; and responsive to the detected valley having reached zero volts, declaring a valley.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end user and/or a third party.

While the use of particular transistors is described herein, other transistors (or equivalent devices) may be used instead. For example, a p-channel field effect transistor (PFET) may be used in place of an n-channel field effect transistor (NFET) with little or no changes to the circuit. Furthermore, other types of transistors may be used (such as bipolar junction transistors (BJTs)). Furthermore, the devices may be implemented in/over a silicon substrate (Si), a silicon carbide substrate (SiC), a gallium nitride substrate (GaN) or a gallium arsenide substrate (GaAs), to name a few examples.

References herein to a field effect transistor (FET) being “on” means that the conduction channel of the FET is present and drain current may flow through the FET. References herein to a FET being “off” means that the conduction channel is not present and drain current does not flow through the FET. A FET that is off, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. In another example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

Modifications are possible in the described embodiments, and other embodiments are possible, within the scope of the claims.

What is claimed is:

1. A device comprising:
a first logic circuit configured to blank out a leakage reset portion of a switching terminal signal, responsive to a first blanking signal;
a second logic circuit configured to blank out a leakage ringing portion of the switching terminal signal, responsive to a second blanking signal;
a third logic circuit configured to distinguish the leakage ringing portion of the switching terminal signal from a valley that reaches zero volts, responsive to a zero voltage detection (ZVD) signal, the valley included in a magnetizing ringing portion of the switching terminal signal; and
a fourth logic circuit configured to declare one or more valleys included in the magnetizing ringing portion of the switching terminal signal, responsive to input from the second and third logic circuits.

2. The device of claim 1, further comprising a slew detect circuit configured to detect slew of the switching terminal signal.

3. The device of claim 2, further comprising:
a first threshold voltage that allows the slew detect circuit to operate as a positive slew detector; and
a second threshold voltage that allows the slew detect circuit to operate as a negative slew detector.

4. The device of claim 1, wherein:
the first logic circuit comprises an AND-gate;
the second logic circuit comprises an AND-gate;
the third logic circuit comprises an AND-gate; and
the fourth logic circuit comprises an OR-gate.

5. The device of claim 1, wherein the first blanking signal has a duration that varies based on a peak current of the power converter.

6. The device of claim 1, wherein the second blanking signal has a fixed duration based on a signal period of the leakage ringing portion.

7. The device of claim 1, further comprising a zero voltage detect circuit configured to detect the valley that reaches zero volts, and generate the ZVD signal.

8. A system comprising:
the device of claim 1;
an input voltage terminal;
an output voltage terminal;
a switching terminal at which the switching terminal signal is provided;
a feedback terminal;
a transformer having a primary winding and a secondary winding, the primary winding coupled between the input voltage terminal and the switching terminal; and
a feedback circuit coupled between the output voltage terminal and the feedback terminal.

9. A device, comprising:
a slew detect circuit having a switching terminal input, and further including a comparator having a threshold voltage input and a comparator output;
a zero current detect circuit having an input coupled to the comparator output, and further including a blanking signal input and a zero current detection (ZCD) signal output;
a first threshold voltage switchably coupled to the threshold voltage input of the comparator;
a second threshold voltage switchably coupled to the threshold voltage input of the comparator; and
an adaptive blanking circuit having a clocking input terminal coupled to the comparator output, and further including a blanking signal output, the blanking signal output coupled to the blanking signal input of the zero current detect circuit.

10. The device of claim 9, wherein the zero current detect circuit further includes a zero voltage detect (ZVD) signal input, the device further comprising:
a zero voltage detect circuit having an input coupled to the switching terminal input of the slew detect circuit, and an output coupled to the ZVD signal input of the zero current detect circuit.

11. The device of claim 10, wherein the comparator of the slew detect circuit is a first comparator, and the zero voltage detect circuit further includes:
a second comparator having an output coupled to the output of the zero voltage detect circuit, the second comparator further having a first input coupled to the switching terminal input of the slew circuit via a biasing circuit, and a second input coupled to a negative voltage reference.

12. The device of claim 9, wherein the adaptive blanking circuit further includes a variable blank delay circuit having an output coupled to the blanking signal output, the variable blank delay circuit further including a blanking control input.

13. The device of claim 12, wherein the adaptive blanking circuit further includes:
a flip-flop coupled to the clocking input, and having a flip-flop output coupled to the variable blank delay circuit;
a first switch coupled between the first threshold voltage and the threshold voltage input of the comparator, the first switch having a control input coupled to the flip-flop output; and
a second switch coupled between the second threshold voltage and the threshold voltage input of the comparator, the second switch having a control input coupled to the flip-flop output via an inverter.

14. The device of claim 13, wherein the inverter is a first inverter, and the flip-flop is coupled to the clocking input via a second inverter.

15. The device of claim 9, wherein the adaptive blanking circuit further includes a drive signal input, the drive signal input coupled to a reset input of the flip-flop.

16. The device of claim 9, wherein the threshold voltage input of the comparator is a first input of the comparator, and the slew detect circuit further includes:
a sensor circuit coupled between the switching terminal input and a second input of the comparator, the sensor circuit including a resistor-capacitor filter and a voltage clamp; and
a current source coupled to between a power supply terminal and the second input of the comparator.

17. The device of claim 9, wherein the zero current detect circuit further includes:
a first AND-gate having first and second inputs coupled to the comparator output and the blanking signal input, respectively, and an output;
a leakage filter having an input coupled to the first AND-gate output, and an output; and
a second AND-gate having first and second inputs coupled to the first AND-gate output and the leakage filter output, respectively.

18. The device of claim 17, further comprising:
a zero voltage detect circuit having an input coupled to the switching terminal input of the slew detect circuit, and an output;
wherein the zero current detect circuit further includes
a third AND-gate having first and second inputs coupled to the first AND-gate output and the zero voltage detect circuit output, respectively, and an output; and
an OR-gate having first and second inputs coupled to the second AND-gate output and the third AND-gate output, respectively, and an output coupled to the ZCD signal output.

19. A method, comprising:
receiving a switching terminal signal, the switching terminal signal including a leakage reset portion, a leakage ringing portion, and a magnetizing ringing portion;
detecting positive slew of the leakage reset portion;
generating a blanking signal to blank out the leakage reset portion;
detecting a negative slew of the switching terminal signal; and
responsive to a valley being detected in the switching terminal signal,
declaring a valley if a leakage filter has expired, the leakage filter having a period that is longer than a period of the leakage ringing portion of the switching terminal signal, or
declaring a valley if the detected valley has reached zero volts.

20. The method of claim 19, wherein:
declaring a valley if the leakage filter has expired includes
determining, prior to declaring a valley, if the leakage filter has expired, and
responsive to the leakage filter having expired, declaring a valley; and
declaring a valley if the detected valley has reached zero volts includes
determining if the detected valley reached zero volts, and
responsive to the detected valley having reached zero volts, declaring a valley.
